(19) United States
(12) Patent Application Publication
(10) Pub. No.: US 2024/0325982 A1
(43) Pub. Date: Oct. 3, 2024

(54) MEMBRANE CHROMATOGRAPHY CASSETTE ASSEMBLY

(71) Applicant: Donaldson Company, Inc., Bloomington, MN (US)

(72) Inventors: Jinxiang Zhou, Greenville, SC (US); Suresh B. Bommineni, Shakopee, MN (US); Graham Temples, Greenville, SC (US); Aflal Rahmathullah, Savage, MN (US)

(21) Appl. No.: 18/625,017

(22) Filed: Apr. 2, 2024

Related U.S. Application Data
(60) Provisional application No. 63/456,777, filed on Apr. 3, 2023.

(51) Int. Cl. B01D 63/08; B01D 15/10; B01D 69/02; G01N 30/92

(52) U.S. Cl. CPC B01D 63/0822; B01D 15/10; B01D 69/02; G01N 30/92; B01D 2325/02834

(57) ABSTRACT

The present technology relates to a cassette assembly having an inlet cassette plate defining an inlet flow path, and an outlet cassette plate defining an outlet flow path. The outlet cassette plate is configured to be arranged in a stack with the inlet cassette plate. A membrane stack is disposed between the inlet cassette plate and the outlet cassette plate. The inlet flow path is configured to be in fluid communication with the outlet flow path through the membrane stack to form an assembly flow path. The cassette assembly is configured to receive an elution solution, and an elution concentration is substantially constant as the inner nominal volume varies.

### RELATED APPLICATIONS

This application claims the benefit under 35 U.S.C. § 119 (e) of U.S. Provisional Patent Application No. 63/456,777 filed on Apr. 3, 2023, titled MEMBRANE CHROMATOGRAPHY CASSETTE ASSEMBLY, which is hereby incorporated by reference in its entirety.

### TECHNOLOGICAL FIELD

The present disclosure is generally related to a membrane chromatography cassette assembly.

### BACKGROUND

Membrane chromatography cassettes may be used, for example, in membrane chromatography, tangential flow filtration (TFF), various microfiltration applications, etc. Various implementations incorporating membrane chromatography cassettes may benefit from increased productivity resulting, for example, from relative increases in filtration capacity and/or relative increases in volumetric flow through such cassettes. However, changing cassette geometries and system flow parameters, which may be avenues through which productivity of individual cassettes may be increased, may negatively impact separation due to changes in liquid flow dynamics through such cassettes.

### SUMMARY

The technology disclosed herein relates to a cassette assembly that has both a singular and a modular configuration, which allows for the assembly to be adaptable to a variety of operating conditions and environments. Membrane chromatography assemblies can incorporate one or more cassettes and can be modified relatively easily to incorporate additional cassettes or fewer cassettes. In membrane chromatography assemblies having multiple cassettes, such cassettes can be arranged in parallel for liquid filtration. Further, the single or modular cassette assemblies may include a membrane stack. The membrane stack may include more than one layers of membranes as defined herein. Still further, the layers of membranes may have different configurations, such as different mean pore sizes. Still further, the elution concentration may be stable as the inner nominal volume varies.

The present technology relates to a cassette assembly having an inlet cassette plate defining an inlet flow path, and an outlet cassette plate defining an outlet flow path. The outlet cassette plate may be configured to be arranged in a stack with the inlet cassette plate. A membrane stack may be disposed between the inlet cassette plate and the outlet cassette plate. The inlet flow path may be configured to be in fluid communication with the outlet flow path through the membrane stack to form an assembly flow path.

In some such embodiments, the inlet flow path may be configured to receive a first fluid including a target molecule. The cassette assembly as a whole may be configured to receive the first fluid including the target molecule. The membrane stack may be configured to retain the target molecule. The assembly flow path may define an inner nominal volume. The cassette assembly may be configured to receive an elution solution after the inlet flow path receives the first fluid. An elution concentration may be substantially constant as the inner nominal volume varies.

Additionally or alternatively, an inlet channel can extend along an effective inlet surface area of the membrane stack in fluid communication with the inlet flow path. Additionally or alternatively, an outlet channel can extend along an effective outlet surface area of the membrane stack towards the outlet flow path. Additionally or alternatively, the membrane stack can include a first membrane layer having a first mean pore size and a second membrane layer having a second mean pore size different from the first mean pore size. Additionally or alternatively, the first mean pore size is 0.30 to 0.60 microns and the second mean pore size is 2.0 to 4.0 microns. Additionally or alternatively, the first membrane layer and the second membrane layer are arranged in a repeating pattern in the stack. Additionally or alternatively, the first mean pore size is 0.50 to 1.50 microns and the second mean pore size is 2.50 to 3.50 microns. Additionally or alternatively, the membrane stack comprises 6 first membrane layers and 15 second membrane layers. Additionally or alternatively, the membrane stack comprises 10 first membrane layers and 30 second membrane layers. Additionally or alternatively, first membrane layer and the second membrane layer are arranged in a repeating pattern of one first membrane layer and three second membrane layers in the stack. Additionally or alternatively, the first membrane layer and the second membrane layer are arranged with one first membrane layer at one end of the membrane stack, and a repeating pattern of one first membrane layer and three second membrane layers in the stack thereafter. Additionally or alternatively, a ratio of an inner nominal membrane stack volume (milliliters) to a fluid feed rate (milliliters/minute) is 5:1. Additionally or alternatively, the membrane stack comprises at least 20 membrane layers. Additionally or alternatively, a ratio of a nominal membrane stack volume to a first fluid feed rate is at least 1:2. Additionally or alternatively, a ratio of a nominal membrane stack volume to an elution solution feed rate is at least 1:1. Additionally or alternatively, a ratio of a nominal membrane stack volume to an elution volume is at least 1:5. Additionally or alternatively, the inner nominal volume is at least 2 milliliters and up to and including 50 milliliters. Additionally or alternatively, the elution concentration is an amount of the retained target molecule per: milliliter of the first fluid over an elution volume. Additionally or alternatively, the elution concentration is at least 0.4 ((milligrams of the retained target molecule) per ((milliliter of the first fluid)/(the elution volume))). Additionally or alternatively, the membrane stack has an effective inlet surface area defined by an effective length and an effective width, and wherein the effective length is at least 2.5 times the effective width.

In some such embodiments, the cassette assembly may include an inlet cassette plate defining an inlet flow path configured to receive a first fluid including a target molecule. The cassette assembly may include an outlet cassette plate configured to be arranged in a stack with the inlet cassette plate, the outlet cassette plate defining an outlet flow path. The cassette assembly may include a membrane stack having at least one membrane layer. The membrane stack may be disposed between the inlet cassette plate and the outlet cassette plate and the membrane stack may be configured to retain the target molecule. The inlet flow path may be configured to be in fluid communication with the outlet flow path through the membrane stack to form an assembly flow path, and the assembly flow path may define an inner nominal volume. The cassette assembly may be configured to receive an elution solution after the inlet flow path receives the first fluid, and a ratio of the inner nominal volume to an elution concentration ((milligrams of the retained target molecule) per ((milliliter of the first fluid)/(the elution volume))) may remain 1:1 as the inner nominal volume varies.

Additionally or alternatively, an inlet channel can extend along an effective inlet surface area of the membrane stack in fluid communication with the inlet flow path. Additionally or alternatively, an outlet channel can extend along an effective outlet surface area of the membrane stack towards the outlet flow path. Additionally or alternatively, the membrane stack can include a first membrane layer having a first mean pore size and a second membrane layer having a second mean pore size different from the first mean pore size. Additionally or alternatively, the first mean pore size is 0.30 to 0.60 microns and the second mean pore size is 2.0 to 4.0 microns. Additionally or alternatively, the first membrane layer and the second membrane layer are arranged in a repeating pattern in the stack. Additionally or alternatively, the first mean pore size is 0.50 to 1.50 microns and the second mean pore size is 2.50 to 3.50 microns. Additionally or alternatively, the membrane stack comprises 6 first membrane layers and 15 second membrane layers. Additionally or alternatively, the membrane stack comprises 10 first membrane layers and 30 second membrane layers. Additionally or alternatively, first membrane layer and the second membrane layer are arranged in a repeating pattern of one first membrane layer and three second membrane layers in the stack. Additionally or alternatively, the first membrane layer and the second membrane layer are arranged with one first membrane layer at one end of the membrane stack, and a repeating pattern of one first membrane layer and three second membrane layers in the stack thereafter. Additionally or alternatively, a ratio of an inner nominal membrane stack volume (milliliters) to a fluid feed rate (milliliters/minute) is 5:1. Additionally or alternatively, the membrane stack comprises at least 20 membrane layers. Additionally or alternatively, a ratio of a nominal membrane stack volume to a first fluid feed rate is at least 1:2. Additionally or alternatively, a ratio of a nominal membrane stack volume to an elution solution feed rate is at least 1:1. Additionally or alternatively, a ratio of a nominal membrane stack volume to an elution volume is at least 1:5. Additionally or alternatively, the inner nominal volume is at least 2 milliliters and up to and including 50 milliliters. Additionally or alternatively, the elution concentration is an amount of the retained target molecule per: milliliter of the first fluid over an elution volume. Additionally or alternatively, the elution concentration is at least 0.4 ((milligrams of the retained target molecule) per ((milliliter of the first fluid)/(the elution volume))). Additionally or alternatively, the membrane stack has an effective inlet surface area defined by an effective length and an effective width, and wherein the effective length is at least 2.5 times the effective width.

In some such embodiments, the cassette assembly may include an inlet cassette plate defining an inlet flow path configured to receive a first fluid including a target molecule. The cassette assembly may include an outlet cassette plate configured to be arranged in a stack with the inlet cassette plate, the outlet cassette plate defining an outlet flow path. The cassette assembly may include a membrane stack having at least one membrane layer. The membrane stack may be disposed between the inlet cassette plate and the outlet cassette plate and the membrane stack may be configured to retain the target molecule. The inlet flow path may be configured to be in fluid communication with the outlet flow path through the membrane stack to form an assembly flow path, and the assembly flow path may define an inner nominal volume.

Additionally or alternatively, an inlet channel can extend along an effective inlet surface area of the membrane stack in fluid communication with the inlet flow path. Additionally or alternatively, an outlet channel can extend along an effective outlet surface area of the membrane stack towards the outlet flow path. Additionally or alternatively, the membrane stack can include a first membrane layer having a first mean pore size and a second membrane layer having a second mean pore size different from the first mean pore size. Additionally or alternatively, the first mean pore size is 0.30 to 0.60 microns and the second mean pore size is 2.0 to 4.0 microns. Additionally or alternatively, the first membrane layer and the second membrane layer are arranged in a repeating pattern in the stack. Additionally or alternatively, the first mean pore size is 0.50 to 1.50 microns and the second mean pore size is 2.50 to 3.50 microns. Additionally or alternatively, the membrane stack comprises 6 first membrane layers and 15 second membrane layers. Additionally or alternatively, the membrane stack comprises 10 first membrane layers and 30 second membrane layers. Additionally or alternatively, first membrane layer and the second membrane layer are arranged in a repeating pattern of one first membrane layer and three second membrane layers in the stack. Additionally or alternatively, the first membrane layer and the second membrane layer are arranged with one first membrane layer at one end of the membrane stack, and a repeating pattern of one first membrane layer and three second membrane layers in the stack thereafter. Additionally or alternatively, a ratio of an inner nominal membrane stack volume (milliliters) to a fluid feed rate (milliliters/minute) is 5:1. Additionally or alternatively, the membrane stack comprises at least 20 membrane layers. Additionally or alternatively, a ratio of a nominal membrane stack volume to a first fluid feed rate is at least 1:2. Additionally or alternatively, a ratio of a nominal membrane stack volume to an elution solution feed rate is at least 1:1. Additionally or alternatively, a ratio of a nominal membrane stack volume to an elution volume is at least 1:5. Additionally or alternatively, the inner nominal volume is at least 2 milliliters and up to and including 50 milliliters. Additionally or alternatively, the elution concentration is an amount of the retained target molecule per: milliliter of the first fluid over an elution volume. Additionally or alternatively, the elution concentration is at least 0.4 ((milligrams of the retained target molecule) per ((milliliter of the first fluid)/(the elution volume))). Additionally or alternatively, the membrane stack has an effective inlet surface area defined by an effective length and an effective width, and wherein the effective length is at least 2.5 times the effective width.

The present technology relates to a cassette assembly having an inlet cassette plate defining an inlet flow path, and an outlet cassette plate defining an outlet flow path. The outlet cassette plate is configured to be arranged in a stack with the inlet cassette plate. A membrane stack is disposed between the inlet cassette plate and the outlet cassette plate. The membrane stack has a first membrane layer having a first mean pore size and a second membrane layer having a second mean pore size different than the first mean pore size. The inlet flow path is configured to be in fluid communication with the outlet flow path through the membrane stack to form an assembly flow path.

In some such embodiments, the first mean pore size is 0.30 to 0.60 microns and the second mean pore size is 2.0 to 4.0 microns. Additionally or alternatively, the first membrane layer and the second membrane layer are arranged in a repeating pattern in the stack. Additionally or alternatively, the assembly has an inlet channel extending along an effective inlet surface area of the membrane stack in fluid communication with the inlet flow path and an outlet channel extending along an effective outlet surface area of the membrane stack towards the outlet flow path. Additionally or alternatively, the membrane stack has at least 30 membrane layers. Additionally or alternatively, the membrane stack has an effective inlet surface area defined by an effective length and an effective width, and the effective length is at least 2.5 times the effective width. Additionally or alternatively, an outlet channel spacer is positioned in the outlet channel, where the outlet channel spacer is configured to accommodate fluid flow. Additionally or alternatively, an inlet channel spacer is positioned in the inlet channel, where the inlet channel spacer is configured to accommodate fluid flow. Additionally or alternatively, a first end plate is operatively couplable to the inlet cassette plate. A second end plate is operatively couplable to the outlet cassette plate. The first end plate is an inlet port configured to extend to the inlet flow path and the second end plate has an outlet port configured for fluid communication with the outlet flow path.

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF THE DRAWINGS

FIG. 1 is a perspective view of an example membrane chromatography cassette assembly consistent with various embodiments.

FIG. 2 is a detail partial cross-sectional detail view of the example membrane chromatography cassette assembly consistent with FIG. 1.

FIG. 3 is a plan view of an example channel spacer for use with an example membrane chromatography cassette assembly consistent with FIG. 1.

FIG. 4 is a perspective view of another example membrane chromatography cassette assembly consistent with various embodiments.

FIG. 5 is a perspective cross-sectional view of FIG. 4.

FIG. 6 illustrates example dynamic binding capacity resulting from variations to the membrane layers of the membrane stack in example membrane chromatography cassette assemblies.

FIG. 7 illustrates example elution volume resulting from variations to the membrane layers of the membrane stack in example membrane chromatography cassette assemblies.

FIG. 8 illustrates example elution pressure resulting from variations to the membrane layers of the membrane stack in example membrane chromatography cassette assemblies.

FIG. 9 illustrates example dynamic binding capacity resulting from variations to the membrane layers of the membrane stack in example membrane chromatography cassette assemblies.

FIG. 10 illustrates example elution volume resulting from variations to the membrane layers of the membrane stack in example membrane chromatography cassette assemblies.

FIG. 11 illustrates example elution pressure resulting from variations to the membrane layers of the membrane stack in example membrane chromatography cassette assemblies.

FIG. 12 illustrates example elution concentration resulting from variations to the membrane layers of the membrane stack in example membrane chromatography cassette assemblies.

FIG. 13 illustrates example intensity of absorbance resulting from variations to the membrane layers of the membrane stack in example membrane chromatography cassette assemblies.

FIG. 14 illustrates example elution pressure resulting from variations to the membrane layers of the membrane stack in example membrane chromatography cassette assemblies.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, cassette plates, fluid conduits such as tubing, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

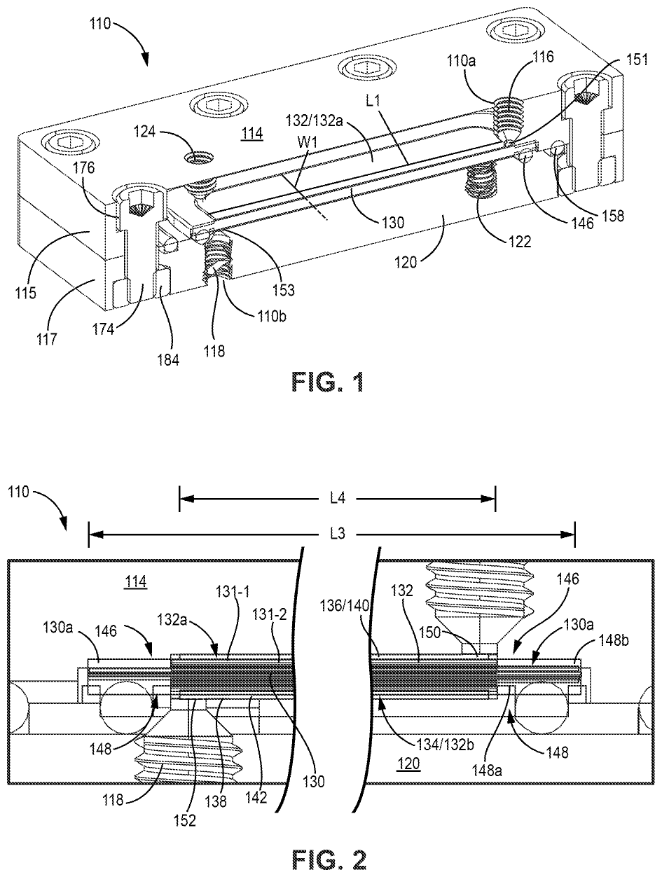

Cassette assemblies consistent with the technology disclosed herein can have a variety of different configurations. FIG. 1 depicts a perspective cross-sectional schematic of one example embodiment of a cassette assembly 110, and FIG. 2 depicts a schematic cross-sectional detail view of the example cassette assembly 110, with portions of the cassette assembly 110 omitted.

FIGS. 1 and 2 can be viewed with the following description. The cassette assembly 110 is generally configured to filter a fluid that is passed therethrough. The cassette assembly 110 generally has an inlet cassette plate 114, an outlet cassette plate 120, and a membrane stack 130 disposed between the inlet cassette plate 114 and the outlet cassette plate 120. The cassette assembly 110 is generally configured to filter fluid passing therethrough. The present disclosure does not limit the fluid flow direction to any specific orientation.

The inlet cassette plate 114 can define an inlet flow path 116. The inlet flow path 116 defines a path for fluid flow from an assembly inlet 110a into the cassette assembly 110 through the inlet cassette plate 114 during a fluid filtration application. The inlet flow path 116 can extend axially through the inlet cassette plate 114.

The outlet cassette plate 120 is generally configured to be arranged in a stack with the inlet cassette plate 114. The outlet cassette plate 120 of each cassette assembly 110 generally defines an outlet flow path 118. The outlet flow path 118 defines a path for fluid flow to an assembly outlet 110b during a fluid filtration application. The outlet flow path 118 can extend axially through the outlet cassette plate 120. The inlet flow path 116 can be generally configured for fluid communication with the outlet flow path 118.

The inlet cassette plate 114 and the outlet cassette plate 120 can be constructed of a variety of different materials and combinations of materials. In some embodiments, one or both of the cassette plates 114, 120 is plastic. In other embodiments, one or both of the cassette plates 114, 120 is metal. In one example, one or both of the cassette plates 114, 120 are injection-molded, 3D printed, machined, or combinations thereof. In some embodiments the inlet cassette plate 114 is constructed of the same material as the outlet cassette plate 120. In some other embodiments the inlet cassette plate 114 is constructed of a different material than the outlet cassette plate 120.

In various embodiments, the inlet flow path 116 and the outlet flow path 118 are in fluid communication via the membrane stack 130 of the cassette assembly 110. The membrane stack 130 is disposed between the inlet cassette plate 114 and the outlet cassette plate 120. The membrane stack 130 is generally configured to filter a fluid stream flowing from the inlet flow path 116 to the outlet flow path 118. The membrane stack 130 is configured to separate at least one component in the fluid stream from the fluid stream. Such separation may be realized through one or more of the following processes: chemical binding, binding of biological molecules, particle capture, absorption, adsorption, etc., as the fluid flows along the membrane stack 130, though the membrane stack 130, or a combination of along and through the membrane stack 130. The membrane stack 130 generally has two or more membrane layers. A membrane stack 130 generally has a plurality of membranes which are consecutively layered in the axial direction.

The membrane stack 130 can include a plurality of membrane layers 131, which are more visible in FIG. 2. The plurality of membrane layers 131 can be between 2 and 60 membrane layers 131. In embodiments, the plurality of membrane layers 131 can include at least 30 membrane layers 131. In alternative embodiments, the plurality of membrane layers 131 can include at least 5, at least, 15, at least 19, at least 20, at least 30, at least 40, or at least 50 membrane layers 131, etc. In alternative embodiments, the plurality of membrane layers 131 can include less than 60, less than 50, less than 45, less than 35, less than 25, less than 17, less than 9 membrane layers 131 etc.

The membrane layers 131 can be constructed of a variety of different materials and combinations of materials. In various embodiments the membrane layers 131 incorporate a microporous membrane, such as polytetrafluoroethylene (PTFE) or other types of microporous membranes. The membrane layers 131 can be a laminate or composite that includes a breathable membrane, such as a PTFE laminated to a woven or non-woven support layer. In some embodiments one or more of the membrane layers 131 are constructed of a different material than one or more other membrane layers 131 within the membrane stack 130.

For example, the membrane stack 130 may include a first membrane layer 131-1 and a second membrane layer 131-2. The second membrane layer 131-2 is generally stacked on the first membrane layer 131-1. The second membrane layer 131-2 abuts the first membrane layer 131-1 such that a surface area of the second membrane layer 131-2 is in direct contact with a surface area of the first membrane layer 131-1. The first membrane layer 131-1 may have a first mean pore size. The second membrane layer 131-2 may have a second mean pore size. The first and second porosities are different from one another, which can be characterized in terms of mean pore size. The first mean pore size may be 0.5 to 1.50 microns, 0.3 to 0.6 microns, 0.4 to 0.5 microns, or 0.45 microns, in some embodiments (e.g., “Type 2” membrane described further herein). The second mean pore size may be 2.50 to 3.50 microns, 1.0 to 5.0 microns (e.g., “Type 3” membrane described further herein), 2.0 to 4.0 microns, or 3 microns, in some embodiments (e.g., “Type 4” membrane described further herein). In some embodiments, the membrane stack 130 has a plurality of first membrane layers 131-1 and second membrane layers 131-2. The first membrane layers 131-1 and second membrane layers 131-2 can be arranged in a repeating and alternating pattern in the membrane stack.

The “mean pore size” can be determined in accordance with ASTM F316. In various embodiments, capillary flow porometry may be performed using a continuous pressure scan mode to determine the mean pore size. A manufacturer specified wetting liquid is generally used, which is typically a fluorinated fluid. The sample may initially be tested dry, varying low pressure to high pressure, and then tested wet, again varying low pressure to high pressure. The test is typically performed at ambient temperature conditions (20° C. to 25° C.). 256 data points may be collected across the range of the scan of the pressures for both the dry curve and the wet curve. Typically, no tortuosity factor and/or a shape factor will be used (that is, for comparison to other test methods that use an adjustment factor, a factor equal to 1 may be used).

In some embodiments, the inlet cassette plate 114 can define an inlet cassette vent 124. In some embodiments the outlet cassette plate 120 can define an outlet cassette vent 122. The vents 124, 122 are configured to selectively define a path for gas to vent out of the cassette assembly 110. The vents 124, 122 may be open or closed to an ambient environment. The vents 124, 122 can extend axially through its respective cassette plate 114, 120. In various embodiments, the vents 124, 112 are closed during filtration operations. The vents 124, 122 can be opened to release trapped gas prior to or following filtration operations. Some embodiments omit an inlet cassette vent 124, however. Some embodiments omit an outlet cassette vent 122.

Each cassette assembly 110 can further include an inlet channel 136 and an outlet channel 138 (FIG. 2). The inlet channel 136 (FIG. 2) generally defines a path for fluid flow from the inlet flow path 116 along a first lateral surface 132 of the membrane stack 130. The outlet channel 138 generally defines a path for fluid flow along a second lateral surface 134 of the membrane stack 130, which is opposite the first lateral surface 132. The outlet channel 138 extends from the membrane stack 130 to the outlet flow path 118.

The inlet channel 136 extends along an effective inlet surface area 132a of the membrane stack 130. The “effective inlet surface area” is defined as the surface area of the upstream surface of the membrane stack 130, which is the first lateral surface 132, that is directly exposed to the inlet channel 136. The effective inlet surface area 132a will generally be less than a total surface area of the membrane stack 130. The outlet channel 138 extends along an effective outlet surface area of the membrane stack 130. The “effective outlet surface area” is defined as the surface area of the downstream surface of the membrane stack 130, which is the second lateral surface 134, that is exposed to the outlet channel 138.

The total length of the membrane stack 130 is defined by 1.3. The length of the effective surface area of the membrane stack 130, which may be the effective inlet surface area and/or the effective outlet surface area, is defined by L4. The difference between L3 and L4 may be a result of features obstructing fluid flow through portions of the surfaces membrane stack, such as a membrane stack seal 146 (discussed further herein) and/or structures defined by the cassette plates 114, 120. In the current example, a perimeter region 130a of the membrane stack 130 is pinched between the inlet plate 114 and the outlet cassette plate 120 and is not available for filtration, and thus does not define a portion of the effective area. The inlet cassette plate 114 and the outlet cassette plate 120 mutually define a compression structure 148 around the inlet channel 136 and the outlet channel 138. More particularly, in the current example the outlet cassette plate 120 defines an axially extending sidewall 148a around the outlet channel 138 that faces an opposing sidewall 148b of the inlet cassette plate 114 that surrounds the inlet channel 136. The axially extending sidewall 148a and the opposing sidewall 148b form the compression structure 148 that exerts a compression force on the perimeter region 130a of the membrane stack 130, which creates a fluid seal. The axially extending sidewall 148a and the opposing sidewall 148b exert a compression force on the perimeter region 130a of the membrane stack 130 that creates a fluid seal. The compression structure 148 may advantageously prevent fluid bypass therethrough.

The inlet channel 136 can extend laterally from the inlet flow path 116. The inlet channel 136 can extend axially between the inlet cassette plate 114 and the effective inlet surface area 132a of the membrane stack 130. In some embodiments, the inlet channel 136 can have an axial depth that accommodates axial expansion of the membrane stack 130 resulting from fluid flow through the membrane stack 130 with a portion of the axial depth remaining clear of the membrane stack 130 to accommodate fluid flow. In embodiments with a membrane stack, for example, the inlet channel 136 can be sized depending on, for example, the number of membrane layers 131, the material of the membrane layers 131, the desired fluid flow rate through the assembly 110, etc.

The inlet channel 136 of the inlet cassette plate 114 defines an inlet channel length L1 and an inlet channel width W1 (partially visible in FIG. 1). In some embodiments, the ratio of the inlet channel length L1 to the inlet channel width W1 may advantageously result in a relative improvement in flow characteristics in filtration operations. The inlet channel length L1 can be between 1 and 4 times larger than the inlet channel width W1. In alternative embodiments, the inlet channel length L1 can be at least 1 time, at least 1.5 times, at least 2 times, at least 2.5 times, at least 3 times, at least 3.5 times, at least 4 times the inlet channel width W1, etc., and/or can be less than 4 times, less than 3.75 times, less than 3.25 times, less than 2.75 times, less than 2.25 times, less than 1.75 times, less than 1.25 times the inlet channel width W1, etc.

The outlet channel 138 of the outlet cassette plate 120 can define an outlet channel length and an outlet channel width, similar to the inlet channel length and width, except with respect to the outlet channel. The outlet channel length L2 can have a ratio with the outlet channel width W2 consistent with that discussed above with respect to the inlet channel length L1 and the inlet channel width W1.

The outlet channel 138 can extend laterally towards the outlet flow path 118. The outlet channel 138 can be in fluid communication with the outlet flow path 118. The outlet channel 138 can extend axially between the effective outlet surface area 132b of the membrane stack 130 and the outlet cassette plate 120. In some embodiments, the outlet channel 138 can have an axial depth that accommodates axial expansion of the membrane stack 130 resulting from fluid flow through the membrane stack 130 with a portion of the axial depth remaining clear of the membrane stack 130 to accommodate fluid flow. In embodiments with a membrane stack, for example, the outlet channel 138 can be sized depending on, for example, the number of membrane layers 131, the material of the membrane layers 131, the desired fluid flow rate through the assembly 110, etc.

In some embodiments, the inlet channel 136 can be defined by at least one of the inlet cassette plate 114, the membrane stack 130, the effective inlet surface area 132a, and the inlet flow path 116. The outlet channel 138 can be defined by at least one of the outlet cassette plate 120, the membrane stack 130, the effective outlet surface area 132b, and the outlet flow path 118. In some embodiments, the channels 136, 138 may be defined by any combination of the listed components, and additionally can be defined by one or more seals, discussed further herein.

In some embodiments, the effective width W4 is equal to the width of the effective inlet surface area 132a and the width of the effective outlet surface area 132b. In alternative embodiments, the effective width W4 may be different at the effective inlet surface area 132a from the effective outlet surface area 132b such that there is an inlet effective width and a different outlet effective width (not shown). In some embodiments, the effective length L4 is equal to the length of the effective inlet surface area 132a and the length of the effective outlet surface area 132b. In alternative embodiments, the effective length L4 of the effective inlet surface area 132a may be different than the effective length of the effective outlet surface area 132b such that there is an inlet effective length and an outlet effective length (not shown).

The effective length L4 can be between 1 times and 4 times larger than the effective width W4. In alternative embodiments, the effective length L4 can be at least 1 times, at least 1.5 times, at least 2 times, at least 2.5 times, at least 3 times, at least 3.5 times, or at least 4 times the effective width W4, etc. In alternative embodiments, the effective length L4 can be less than 4 times, less than 3.75 times, less than 3.25 times, less than 2.75 times, less than 2.25 times, less than 1.75 times, or less than 1.25 times the effective width W4, etc.

The cassette assembly 110 can further include one or more channel spacers 140, 142 (best visible in FIG. 2) that are each configured to be received by the inlet channel 136 and/or the outlet channel 138. A channel spacer may be inserted into the inlet and/or outlet channels 136, 138 to ensure, for example, that the membrane stack 130 does not expand into and block the channels. In the current example, the cassette assembly 110 has an inlet channel spacer 140 and an outlet channel spacer 142. The inlet channel spacer 140 is generally configured to retain a minimum axial depth of the inlet channel 136 to maintain fluid flow along the inlet channel 136. As mentioned above, the axial depth of the inlet channel 136 may be reduced upon system use due to membrane stack expansion, for example, and the inlet channel spacer 140 may advantageously oppose such expansion. The inlet channel spacer 140 can be positioned in the inlet channel 136. The inlet channel spacer 140 is positioned between the inlet cassette plate 114 and the membrane stack 130. In some embodiments, the inlet channel spacer 140 abuts the inlet cassette plate 114 and the membrane stack 130.

The outlet channel spacer 142 is generally configured to retain a minimum axial depth of the outlet channel 138 to accommodate fluid flow along the outlet channel 138. The axial depth of the outlet channel 138 may be reduced upon system use due to membrane stack expansion, and the outlet channel spacer 142 may advantageously oppose such expansion. The outlet channel spacer 142 can be positioned in the outlet channel 138. The outlet channel spacer 142 is positioned between the outlet cassette plate 120 and the membrane stack 130. In some embodiments, the outlet channel spacer 142 abuts the outlet cassette plate 120 and the membrane stack 130.

The inlet channel spacer 140 and/or the outlet channel spacer 142 may be constructed of a variety of different materials and combinations of materials. In some embodiments, the spacer 140, 142 is plastic. The spacer can be a woven or non-woven material such as a scrim layer. In other embodiments, the spacer 140, 142 is constructed of metal. In one example, the spacer 140, 142 is injection-molded, 3D printed or the like. The spacer 140, 142 can be constructed of an elastomeric material such as, for example, rubber, silicone, polyurethane, or other elastomeric materials. The spacer 140, 142 can be retained with friction and/or compression forces. Such friction forces can be among, for example, between the spacer 140, 142 and the membrane stack 130, and between the spacer 140, 142 and the corresponding cassette plate 114, 120.

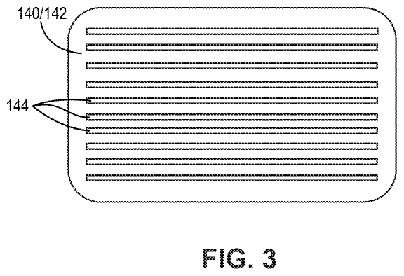

The channel spacers 140, 142 (FIGS. 2, 3) generally define lateral and axial openings to accommodate fluid flow through the channel spacers 140, 142 to the membrane stack 130. In some embodiments, at least one of the inlet channel spacer 140 and the outlet channel spacer 142 can include lateral ridges 144 (FIG. 3) extending across the membrane stack 130. The lateral ridges 144 are generally configured to define a structure to retain the axial depth of the respective channel for fluid flow. The lateral ridges may advantageously provide rigidity to the respective spacer. The lateral ridges 144 may further advantageously guide fluid flow across the respective surface area of the membrane stack 130. The lateral ridges 144 may extend laterally along at least a portion of the channel length of the respective channel within which the spacer is positioned. The lateral ridges 144 may extend axially between the membrane stack 130 and the adjacent cassette plate.

In some embodiments, the cassette assembly 110 includes at least one of an inlet retaining feature 150 and an outlet retaining feature 152, as illustrated in FIG. 2. The inlet and outlet retaining features 150, 152 may advantageously prevent the membrane stack 130 from deforming into the inlet flow path 116 and the outlet flow path 118, respectively. The inlet and outlet retaining features 150, 152 may not be configured to cover as much of the inlet and outlet flow paths 116, 118, respectively, compared to the one or more channel spacers 140, 142, which may be configured to cover more of the inlet and outlet flow paths 116, 118, respectively. In some embodiments, the cassette assembly 110 may include the one or more channel spacers 140, 142 and the one or more retaining features 150, 152. In alternative embodiments, the cassette assembly 110 may include only the channel spacers 140, 142 without the retaining features 150, 152. In further alternative embodiments, the cassette assembly 110 may include only the retaining features 150, 152, without the channel spacers 140, 142. In embodiments with both the channel spacers 140, 142 and the retaining features 150, 152, the channel spacers 140, 142 may or may not laterally align, or overlay, the retaining features 150, 152.

The inlet retaining feature 150 may be configured to cover an inlet opening 151 (FIG. 1) of the inlet flow path 116. The inlet retaining feature 150 may extend across the inlet opening 151 of the inlet flow path 116. The inlet opening 151 of the inlet flow path 116 may define an interface between the inlet flow path 116 and the inlet channel 136. For example, in some embodiments (and as illustrated), the interface may be substantially planar and may be substantially parallel to the membrane stack 130. In alternative embodiments (not shown), the interface may be non-planar.

The outlet retaining feature 152 may be configured to cover an outlet opening 153 (FIG. 1) of the outlet flow path 118. The outlet retaining feature 152 may extend across the outlet opening 153 of the outlet flow path 118. The outlet opening 153 of the outlet flow path 118 may define an interface between the outlet flow path 118 and the outlet channel 138. For example, in some embodiments (and as illustrated), the interface may be substantially planar and may be substantially parallel to the membrane stack 130. In alternative embodiments (not shown), the interface may be non-planar.

Preliminary testing suggests that using both the inlet retaining feature 150 and the outlet retaining feature 152 in some implementations results in better flow distribution and flow uniformity across the entirety of the effective surface area of the membrane stack 130 and allows for the direction of the flow to be reversed at any time without undesirable expansion of the membrane stack 130 into the inlet or outlet flow paths 116, 118.

The inlet and outlet retaining features 150, 152 can be constructed of a variety of different materials and combinations of materials. In some embodiments, one or both of the retaining features 150, 152 is plastic and includes perforations therethrough for fluid flow. In other embodiments, one or both of the retaining features 150, 152 is metal and includes perforations therethrough for fluid flow. For example, in one embodiment, the inlet and/or outlet retaining features 150, 152 may be constructed of stainless steel. In one example, one or both of the retaining features 150, 152 are injection-molded, 3D printed, machined, or combinations thereof, and include perforations therethrough for fluid flow. In some embodiments the inlet retaining feature 150 is constructed of the same material as the outlet retaining feature 152. In some other embodiments the inlet retaining feature 150 is constructed of a different material than the outlet retaining feature 152.

The inlet and outlet retaining features 150, 152 may be connected to the inlet and outlet cassette plates 114, 120, respectively, using a weld, adhesive, or mechanical attachment. For example, the inlet and outlet retaining features 150, 152 may include one or more apertures around the perimeter of the inlet and outlet retaining features 150, 152, and each aperture may be melted to a boss on the respective cassette plates 114, 120.

Each cassette assembly 110 can further include a membrane stack seal 146. The membrane stack seal 146 is generally configured to fluidically seal among the membrane stack 130 and each of the inlet cassette plate 114 and the outlet cassette plate 120 to prevent fluid bypass of the membrane stack 130 during fluid filtration. The membrane stack seal 146 can be installed between the inlet cassette plate 114 and the outlet cassette plate 120. In some embodiments, the membrane stack seal 146 can be in contact with the inlet cassette plate 114 and the outlet cassette plate 120. In some embodiments the membrane stack seal 146 is in contact with one of the inlet cassette plate 114 and the outlet cassette plate 120. The membrane stack seal 146 can be configured to fluidically seal a perimeter region 130a of the membrane stack 130, a perimeter region of the inlet channel 136, and a perimeter region of the outlet channel 138.

In alternative embodiments, the membrane stack seal can be more than one seal. The membrane stack seal 146 can include a first o-ring inserted between the perimeter region on the first lateral surface (such as the upstream surface) of the membrane stack 130 and the inlet cassette plate 114. The membrane stack seal 146 can include a second o-ring inserted between the perimeter region on a second lateral surface (such as the downstream surface) of the membrane stack 130 and the outlet cassette plate 120. In further alternative embodiments, the membrane stack seal 146 may be a weld, for example, or an adhesive. A weld may be formed between, or an adhesive may be used to seal together, the cassette plates 114, 120, or the membrane stack 130 and the inlet cassette plate 114, or the membrane stack 130 and the outlet cassette plate 120, or any combination thereof.

The membrane stack seal 146 may be constructed of a variety of different materials and combinations of materials. In various embodiments the membrane stack seal 146 can be constructed of an elastomeric material such as rubber, silicone, polyurethane, and the like. In some other embodiments, the membrane stack seal 146 is a molded plastic. In yet other embodiments, the membrane stack seal 146 is a metal. In one example, the membrane stack seal 146 is injection-molded, 3D printed or formed through other types of processes. The membrane stack seal 146 can include an overmolded gasket. The overmolded gasket can be injection molded around the perimeter of the membrane stack 130 to form the membrane stack seal 146. In some embodiments, the membrane stack seal 146 is defined by a relatively tight coupling of the cassette plates 114, 120 that forms a liquid tight seal via compression forces around the membrane stack 130. In such an example, a membrane stack seal that is a separate component from the cassette plates 114, 120 can be omitted.

The cassette assembly 110 can further include an attachment seal 158. The attachment seal 158 is generally configured to fluidically seal between the inlet and outlet cassette plates 114, 120. The attachment seal 158 can be inserted between the inlet cassette plate 114 and the outlet cassette plate 120. The attachment seal 158 can extend laterally around and outside a periphery of the membrane stack seal 146. The attachment seal 158 can extend laterally around and outside of a periphery of the membrane stack 130. The attachment seal 158 can be positioned laterally between the axial surfaces (e.g., 115, 117) of the inlet and outlet cassette plates 114, 120, respectively, and the membrane stack seal 146. The attachment seal 158 can be constructed of a variety of different materials and combinations of materials consistent with those discussed above with reference to the membrane stack seal. The attachment seal 158 may be retained with friction and/or compression forces, for example, and/or may be retained using a fastener. Such forces can be among the attachment seal 158, the inlet cassette plate 114 and the outlet cassette plate 120.

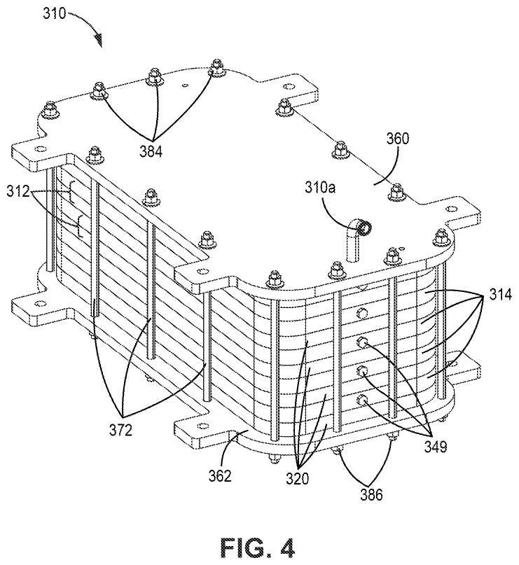

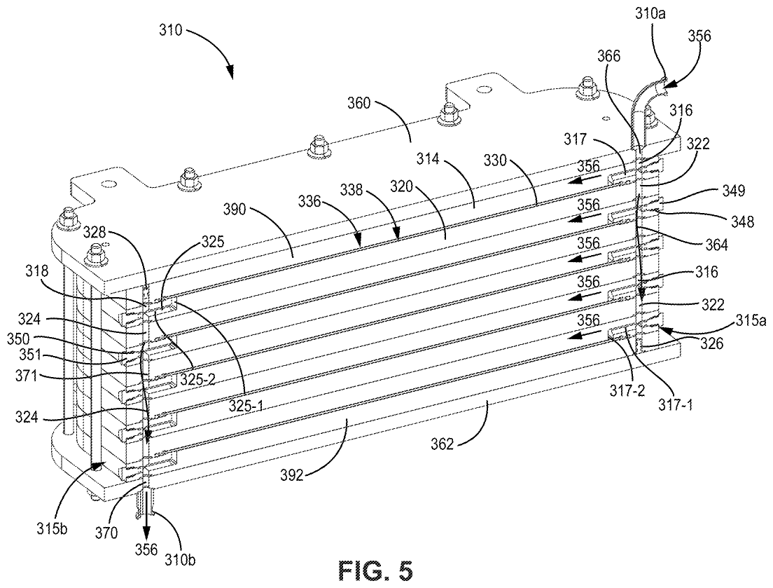

Membrane chromatography cassette assemblies consistent with the technology disclosed herein can have a variety of different configurations. FIGS. 4-5 depict perspective views of another example membrane chromatography cassette assembly 310, and FIGS. 4-5 can be viewed together with the following description. The cassette assembly 310 is generally configured to filter a fluid that is passed therethrough. The cassette assembly 310 generally has an inlet cassette plate 314, an outlet cassette plate 320, and a membrane stack 330. It will be understood the components referenced in the description of FIGS. 1 and 2 herein are consistent with the descriptions of the same components described elsewhere herein unless contradictory to the current description or corresponding figures.

As illustrated, there are a plurality of cassettes 312 stacked within the cassette assembly 310. Each of the plurality of cassettes 312 are configured to filter fluid passing therethrough, and the cassettes 312 are generally arranged in parallel with respect to fluid flow through the cassette assembly 310. Parallel fluid flow through multiple cassettes can accommodate increased filtration capacity and/or reduced pressure drop compared to fluid flow through a single cassette or compared to fluid flow through cassettes arranged in series. Parallel fluid flow 356 through the assembly 310 is represented in FIG. 5. In some implementations, there may be a single cassette 312 within the cassette assembly 310, at least as described with respect to the assemblies 110, 310 discussed herein.

The cassette assembly 310 has a fluid inlet flow path 364. The fluid inlet flow path 364 fluidically couples an assembly inlet 310a of the cassette assembly 310 to each of the individual cassettes 312 within the assembly 310. The fluid inlet flow path 364 extends axially through each of the cassettes 312 in the cassette assembly 310. As illustrated, the cassette assembly 310 has a fluid outlet cassette flow path 371. The fluid outlet cassette flow path 371 fluidically couples an assembly outlet 310b of the cassette assembly 310 to each of the individual cassettes 312 within the assembly. The fluid outlet cassette flow path 371 extends axially through each of the cassettes 312 in the cassette assembly 310. The fluid inlet flow path 364 and the fluid outlet cassette flow path 371 are in fluid communication through each of the cassettes 312. More particularly, the fluid inlet flow path 364 and the fluid outlet cassette flow path 371 are in fluid communication through each membrane stack 330 of each cassette 312.

The cassette assembly 310 described in this particular example is modular, and different numbers of cassettes 312 can be used to form the cassette assembly 310. This may be advantageous as the cassette assembly 310 can be optimized to accommodate various operating specifications.

Each individual cassette 312 within the cassette assembly 310 has an inlet cassette plate 314, an outlet cassette plate 320, and a membrane stack 330 disposed between the inlet cassette plate 314 and the outlet cassette plate 320. The outlet cassette plate 320 can be configured to be arranged in a stack with the inlet cassette plate 314. In some embodiments the assembly 310 has a single inlet cassette plate 314 and a single outlet cassette plate 320 in an assembly that has a single cassette 312. In some implementations, such as the current example, the assembly 310 includes more than one inlet cassette plate 314 and more than one outlet cassette plate 320 where there is more than one cassette 312 in the assembly 310.

In the current example, each inlet cassette plate 314 can define an inlet flow path 316 and an outlet flow path 324, which can be referred to as the “inlet cassette inlet flow path” 316 and the “inlet cassette outlet flow path” 324, respectively. The inlet cassette flow path 316 defines a path for inlet fluid flow from the assembly inlet 310a into the cassette 312 during a fluid filtration application. The inlet cassette outlet flow path 324 defines a path for outlet fluid flow out of the cassette 312 during a fluid filtration application. The inlet cassette flow path 316 can extend axially through the inlet cassette plate 314. The inlet cassette outlet flow path 324 can extend axially through the inlet cassette plate 314. The inlet cassette flow path 316 is generally configured for fluid communication with the inlet cassette outlet flow path 324.

The outlet cassette plate 320 of each cassette assembly 310 can define an inlet flow path 322 and an outlet flow path 318, which can be referred to as the “outlet cassette inlet flow path” 322 and the “outlet cassette outlet flow path” 318, respectively. The outlet cassette inlet flow path 322 defines a path for inlet fluid flow during a fluid filtration application. The outlet cassette outlet flow path 318 defines a path for outlet fluid flow during a fluid filtration application. The outlet cassette inlet flow path 322 can extend axially through the outlet cassette plate 320. The outlet cassette outlet flow path 318 can extend axially through the outlet cassette plate 320. The outlet cassette inlet flow path 322 can be generally configured for fluid communication with the inlet cassette inlet flow path 316, as described further herein. The outlet cassette inlet flow path 322 can be generally configured for fluid communication with the outlet cassette outlet flow path 318. The outlet cassette inlet flow path 322 can be generally configured for fluid communication with the inlet cassette outlet flow path 324.

The inlet cassette flow path 316 can be configured to be laterally aligned with the outlet cassette inlet flow path 322, which together form a portion of the fluid inlet flow path 364 of the assembly 310. “Laterally aligned” is used herein to mean that the inlet flow paths 316, 322 overlap in the lateral direction. The lateral direction is defined as any direction orthogonal to the axial direction. The axial direction is parallel to the direction of stacking of the inlet cassette plate 314 and the outlet cassette plate 320. In some embodiments, the inlet cassette flow path 316 and the outlet cassette inlet flow path 322 are configured for fluid communication to accommodate fluid flow, such as in the axial direction. As such, the fluid inlet flow path 364 can extend axially through the cassette assembly 310, including each inlet cassette plate 314 and each outlet cassette plate 320. Each outlet cassette outlet flow path 318 can be configured to be laterally aligned with each inlet cassette outlet flow path 324, which together form a portion of the fluid outlet cassette flow path 371 of the cassette assembly 310. The fluid outlet cassette flow path 371 extends axially through the cassette assembly 310, including the inlet cassette plate 314 and the outlet cassette plate 320.

In various embodiments, the inlet cassette flow path 316 and the outlet cassette outlet flow path 318 are in fluid communication via the membrane stack 330 of the cassette 312. The membrane stack 330 is consistent with membrane stacks described elsewhere herein.

Each cassette 312 can further include an inlet channel 336 and an outlet channel 338. The inlet channel 336 and the outlet channel 338 are consistent with inlet channels and outlet channels described elsewhere herein. Each cassette 312 can further include one or more channel spacers that are each configured to be received by the inlet channel and/or the outlet channel. Channel spacers are described elsewhere herein. Each cassette 312 can further include sealing structures such as a membrane stack seal and an attachment seal 158 as described elsewhere herein.

Each cassette 312 can further include an inlet flow path extension 317 and an outlet flow path extension 325, as illustrated in FIG. 5. These extensions are configured to fluidically couple the inlet and outlet cassette flow paths to the inlet and outlet channels, respectively. The inlet flow path extension 317 can be defined by the inlet cassette plate 314. The inlet flow path extension 317 can be configured to fluidically couple the inlet cassette flow path 316 and the inlet channel 136. The inlet flow path extension 317 can include a first portion 317-1 and a second portion 317-2. The first portion 317-1 can extend laterally from the inlet cassette flow path 316 towards the inlet channel 136. In the current example, the second portion 317-2 extends axially from the first portion 317-1 to the inlet channel 136. The second portion 317-2 can be in fluid communication with the inlet channel 136 towards one lateral end of the inlet channel 136. In some embodiments, the second portion 317-2 can be in fluid communication with the inlet channel 136 at one lateral end of the inlet channel 136.

The outlet cassette flow path extension 325 can be defined by the outlet cassette plate 320. The outlet cassette flow path extension 325 can fluidically couple the outlet cassette outlet flow path 318 and the outlet channel 338. The outlet cassette flow path extension 325 can include a first portion 325-1 and a second portion 325-2. The first portion 325-1 can extend axially from the outlet channel 338 to the second portion 325-2. The second portion 325-2 can extend laterally from the first portion 325-1 to the outlet cassette outlet flow path 318. The first portion 325-1 can be fluidically coupled to the outlet channel 338 towards the opposite end of the effective length 1.4 (illustrated in FIG. 2) of the membrane stack 330 relative to the inlet extension first portion 325-1.

In alternative embodiments, the extensions do not define 90-degree segments relative to each other or the corresponding fluid flow path as shown and can instead define one or more curved segments. In further alternative embodiments, the inlet extension is a single segment that extends at an oblique angle from the inlet cassette flow path 316 to the inlet channel such that the inlet extension is not orthogonal to the inlet cassette flow path 316 or the inlet channel. Similarly, the outlet extension 325 may define a single or multiple segments where at least one segment is curved. In some embodiments the outlet extension is a single segment that defines an oblique angle and extends from the outlet channel to the outlet cassette outlet flow path 318 such that the outlet extension is not orthogonal to the outlet cassette outlet flow path 318 or the outlet channel.

In some embodiments, each inlet cassette plate 314 can define a first port 348 (particularly visible in FIG. 5). The first port 348 can be configured to accommodate sampling fluid or removing gas once the cassette assembly 310 has been assembled and/or a fluid filtration has begun. The first port 348 can be in selective fluid communication with the inlet cassette flow path 316. The first port 348 can laterally extend through an axial surface 315a of the inlet cassette plate 314. The first port 348 can extend laterally from the axial surface 315a to the inlet cassette flow path 316. The first port 348 can be axially aligned with the inlet flow path extension 317. “Axially aligned” is used herein to mean that the first port 348 and the inlet flow path extension 317 (particularly the first portion) overlap in the axial direction. The first port 348 and the first portion of the inlet flow path extension 317 can be configured for fluid communication to accommodate fluid flow, such as in the lateral direction. The cassette assembly 310 can further include a first port plug 349. The first port plug 349 can be configured to seal the first port 348. The first port plug 349 can be removable and reinsertable in the first port 348. In some embodiments the first port plug 349 is configured to be permanently sealably disposed in the first port 348.

The outlet cassette plate 320 can define a second port 350 in selective fluid communication with the outlet cassette outlet flow path 318. The second port 350 can laterally extend through an axial surface 315b (FIG. 5) of the outlet cassette plate 320. The cassette assembly 310 can further include a second port plug 351. The second port plug 351 can be configured to seal the second port 350. The second port plug 351 can be removable and reinsertable in the second port 350. In some embodiments the second port plug 351 is configured to be permanently sealably disposed in the second port 350.

The port plugs 349, 351 may be constructed of a variety of different materials and combinations of materials. In some embodiments, the port plugs 349, 351 are a molded plastic. In other embodiments, the port plugs 349, 351 are a metal. In one example, the port plugs 349, 351 are injection-molded, 3D printed or the like. The port plugs 349, 351 can be constructed using, for example, a rubber, silicone, polyurethane, or other elastomeric material. The port plugs 349, 351 can be constructed of a combination of materials such as a metal with a plastic and/or elastomeric coating. In some embodiments, the port plugs 349, 351 can be threaded and screwed into the ports 348, 350, as illustrated in FIGS. 4-5. The port plugs 349, 351 can define threads in such embodiments. The port plugs 349, 351 may each have a head that mates with, for example, a mating feature of one or more tools such as a screwdriver or a wrench. The port plugs 349, 351 can be removable by unscrewing them from the ports 348, 350. In the current example visible in FIGS. 4-5, the port plugs 349, 351 have hexagonal heads that align with, for example, a mating feature of a wrench for removal and reinsertion.

The outlet cassette plate 320 can include an alignment feature. The inlet cassette plate 314 can include a mating alignment feature that is configured to mate with the alignment feature when the cassette plates 314, 320 are properly aligned and stacked. In some embodiments the mating alignment feature can be integral with one of the cassette plates 314, 320. In some other embodiments, the alignment feature can be a separate component (such as a pin, screw, or the like) that is mutually received by openings defined by the outlet cassette plate 320 and the inlet cassette plate 314, such as the fastener 174 depicted in FIG. 1 that receives the inlet cassette plate 114 and the outlet cassette plate 120.

One or more cassettes 312 can be arranged in a stacked configuration to form a cassette assembly 310 consistent with the technology disclosed herein, an example of which is depicted in FIGS. 4-5. The cassette assembly 310 has one or more cassettes 312, where each of the cassettes 312 are consistent with the discussions above. In the stacked configuration, each inlet cassette flow path 316 of each inlet cassette plate 314 laterally aligns with each outlet cassette inlet flow path 322 of each outlet cassette plate 320. Each inlet cassette flow path 316 is sealably coupled to at least one outlet cassette inlet flow path 322. Similarly, in the stacked configuration, each inlet cassette outlet flow path 324 laterally aligns with each outlet cassette outlet flow path 318. The inlet flow paths 316, 322 of each of the cassettes 312 cumulatively define a substantial portion of the fluid inlet flow path 364 of the cassette assembly 310. Similarly, the outlet cassette flow paths 318, 324 cumulatively define a substantial portion of the fluid outlet cassette flow path 371 of the cassette assembly 310.

The cassette assembly 310 has a first cassette plate 390 and a last cassette plate 392. The first cassette plate 390 is the outer most inlet cassette plate 314 in the stack of cassettes. The last cassette plate 392 is the outer most outlet cassette plate 320 in the stack of cassettes. In embodiments where the cassette assembly 310 has a single cassette 312, the first cassette plate 390 is the inlet cassette plate 314 and the last cassette plate 392 is the outlet cassette plate 320. Notably, the inlet cassette outlet flow path 324 of the first cassette plate 390, which can be referred to as the first inlet cassette outlet flow path, defines an inactive volume of the fluid outlet cassette flow path 371. Particularly, fluid flow is directed from the membrane stack of each of the cassettes 312 to the assembly outlet 310b via the fluid outlet cassette flow path 371, and the first inlet cassette outlet flow path is not positioned to receive such fluid flow (such as from a preceding cassette in the stack). Similarly, the outlet cassette inlet flow path 322 of the last cassette plate 392, which can be referred to as the last outlet cassette inlet flow path, defines an inactive volume of the fluid inlet flow path 364 because the last outlet cassette inlet flow path is not positioned to direct fluid to a subsequent cassette. Such inactive volumes of the first inlet cassette outlet flow path and the last outlet cassette inlet flow path may negatively impact filtration operations such as introducing unpredictability in fluid flow or collecting fluid that can become stagnant.

In various embodiments the cassette assembly 310 has an inlet plug 326 and an outlet plug 328. The inlet plug 326 can be configured to be inserted in the last outlet cassette inlet flow path to seal the last outlet cassette inlet flow path (as illustrated in FIG. 5), such that fluid flow into the cassette assembly 310 inlet is directed through the cassettes 312. The inlet plug 326 can be configured to be removable and reinsertable in the last outlet cassette inlet flow path. The outlet plug 328 can be configured to be inserted in the first inlet cassette outlet flow path to seal the first inlet cassette outlet flow path, such that fluid flow from the cassettes is directed to the assembly outlet 310b. The outlet plug 328 can be configured to be removable and reinsertable in the first inlet cassette outlet flow path.

The inlet plug 326 may be inserted by pushing it into the last outlet cassette inlet flow path. Similarly, the outlet plug 328 may be inserted by pushing it into the first inlet cassette outlet flow path. Each plug 326, 328 may be constructed of a variety of different materials and combinations of materials. In some embodiments, the plugs 326, 328 are a plastic component. In other embodiments, one or both plugs 326, 328 are constructed of metal. In one example, the plugs 326, 328 are injection-molded, 3D printed or other material. The plugs 326, 328 can be constructed of, for example, a rubber, silicone, polyurethane, or other elastomeric material. In some embodiments the inlet plug 326 and the outlet plug 328 are constructed of the same material; in other embodiments the inlet plug 326 and the outlet plug 328 are constructed of different materials. The plugs 326, 328 are configured to frictionally engage the corresponding cassette plate 390, 392 that receives the plug. In some embodiments, the plugs sealably engage the corresponding cassette plate 390, 392 that receives the plug 326, 328. The plugs 326, 328 can be removable either by pulling them out of their respective paths 322, 318, or by pushing the plugs forward through the paths until them are pushed through their respective cassette plates 314, 320 and exit their respective flow paths 322, 318 from the opposite end from where they were inserted.

The inlet plug 326 and the outlet plug 328 can be configured as a solid cylindrical plug, in some embodiments. In other embodiments a plug 326, 328 can be threaded similar to the port plugs discussed above. In the latter example, the plugs 326, 328 can be removed and reinserted by twisting the plug 326, 328 relative to the cassette it is installed in. In alternative embodiments, the plugs 326, 328 can be configured as a snap-fit plug into their respective paths 322, 318, or can further alternatively be configured as a curable liquid which solidifies inside their respective paths 322, 318.

The plugs 326, 328 may each advantageously fill a corresponding inactive volume within the fluidically coupled pathways and cassettes. Such a configuration may advantageously prevent entry of fluid into the inactive volume during filtration operations, which may improve filtration performance and maximize the volume of filtered fluid. Further, in some embodiments, one or both of the plugs 326, 328 are completely received by their respective paths 322, 318 such that they do not extend outwardly from the cassette 312. Such a configuration may advantageously allow a relatively compact profile of the cassette assembly 310, and may also advantageously negate the need, for example, for an external device to close or plug the paths 322, 318.

The cassette assembly 310 can further include a first end plate 360 and a second end plate 362, as illustrated in FIGS. 4-5. The first end plate 360 can be operatively couplable to an inlet cassette plate 314. Generally, the first end plate 360 is coupled to the first cassette plate 390 of the cassette assembly 310. The second end plate 362 can be operatively couplable to an outlet cassette plate 320 of a cassette 312. Generally, the second end plate 362 is coupled to the last cassette plate 392 of the cassette assembly 310. The end plates 360, 362 may advantageously provide rigidity and structure to the overall assembly 310 and may also advantageously provide a higher resistance to internal pressures resulting from fluid filtration.

The first end plate 360 can include an inlet port 366. The inlet port 366 can be configured to extend to the inlet cassette flow path 316 of the first cassette plate 390. The inlet port 366 is generally configured for fluid communication with the first inlet cassette flow path 316. More particularly, the inlet port 366 defines a fluid flow pathway that is configured to extend from an assembly inlet 310a to the first inlet cassette flow path 316. The second end plate 362 can include the outlet port 370. The outlet port 370 is generally configured for fluid communication with the last outlet cassette outlet flow path 318. The outlet port 370 can be configured to extend from the last outlet cassette outlet flow path 318 to an assembly outlet 310b. More particularly, the outlet port 370 defines a fluid flow pathway through which fluid exits from the last outlet cassette outlet flow path 318 of the assembly 310 through the assembly outlet 310b.

A syringe, tube, or other implement can be used to introduce fluid to the cassette assembly 310. Such implements may include mating components such as, for example, a luer lock, that is configured to sealably engage one or both of the inlet port and the outlet port 370. In alternative embodiments, the inlet port and the outlet port 370 can be configured to mate with, for example, tubing of various sizes, syringes or needles, etc. In further alternative embodiments, the inlet port and the outlet port 370 can be configured to be closeable or sealable and can be further configured to be reopened or unsealed.

The cassette assembly 310 can further include a fastener 372 (FIG. 4). The fastener 372 is generally configured to retain the components of the cassette assembly 310 in an operative configuration. The fastener 372 can be configured to operatively couple the inlet cassette plate 314 and the outlet cassette plate 320. In embodiments with more than one cassette 312, the fastener 372 can operatively couple each of the cassette plates. In the current example, the fastener 372 includes a bolt. In some embodiments, the inlet cassette plate 314 can define a first axial through-hole (not currently visible). The outlet cassette plate 320 can define a second axial through-hole (not currently visible). The first axial through-hole and the second axial through-hole can be configured to laterally align with one another to receive the bolt. There may be more than one bolt, and respectively there may be more than one aligned through-hole to receive the more than one bolt.

In embodiments with the first end plate 360 and/or the second end plate 362, the fastener 372 can be configured to operatively couple the first end plate 360, the inlet cassette plate 314, the outlet cassette plate 320, and the second end plate 362. The first end plate 360 can define a third axial through-hole, and the second end plate 362 can define a fourth axial through-hole. Each of the first, second, third, and fourth axial through-holes can be configured to be laterally aligned with one another to receive the bolt. In some embodiments, at least one of the first, second, third, and fourth axial through-holes may include a threaded hole that is configured to engage the bolt.

In the examples consistent with the embodiment depicted in FIGS. 4-5, the fasteners 372 are configured to engage the first end plate 360 and the second end plate 362. Such fasteners 372 do not directly engage any of the cassettes in the current example. The cassettes 312 are compressibly received by the end plates 360, 362. In particular, upon engagement of the fasteners 372, the end plates 360, 362 are configured to exert a compression force in the axial direction on the cassettes 312, which results in a relatively secured stack of cassettes 312.

In the particular example of FIGS. 4-5, the cassette assembly 310 has fasteners 372 that include a plurality of bolts, where each bolt has a first nut 384 and a second nut 386. The first nut 384 can be configured to receive a first end of the bolt. The second nut 386 can be configured to receive an opposite, second end of the bolt. The first and second nuts 384, 386 can be configured to apply a compression force to the cassette assembly 310. The nuts 384, 386 can specifically apply the compression force to the operatively coupled end plates 360, 362 via the bolt. The first nut 384 can be in contact with the first end plate 360, and the second nut 386 can be in contact with the second end plate 362, or vice versa. Thus, the nuts 384, 386 can apply the compression force to the first and second end plates 360, 362. As a result, the end plates 360, 362 exert compression force on the stack of cassettes, which may advantageously seal each of the fluid flow path(s) through the cassette 312. In alternative embodiments, the fastener 372 may include various clamps, bolts, snap-fits, ties, etc., that can apply the compression force as described herein.

In further alternative embodiments, the fastener 372 may include at least one threaded bolt which threadably engages with the at least one threaded hole defined by at least one of the inlet cassette plate 314, the outlet cassette plate 320, the first end plate 360, and the second end plate 362. In embodiments with the at least one threaded bolt engaged with the at least one threaded hole, at least one of the first and second nuts 384, 386 may not be necessary. The at least one of the first and second nuts 384, 386 may not be necessary because of the threaded engagement between the threaded bolt and the threaded hole.

### Testing of Membrane Stack Configurations

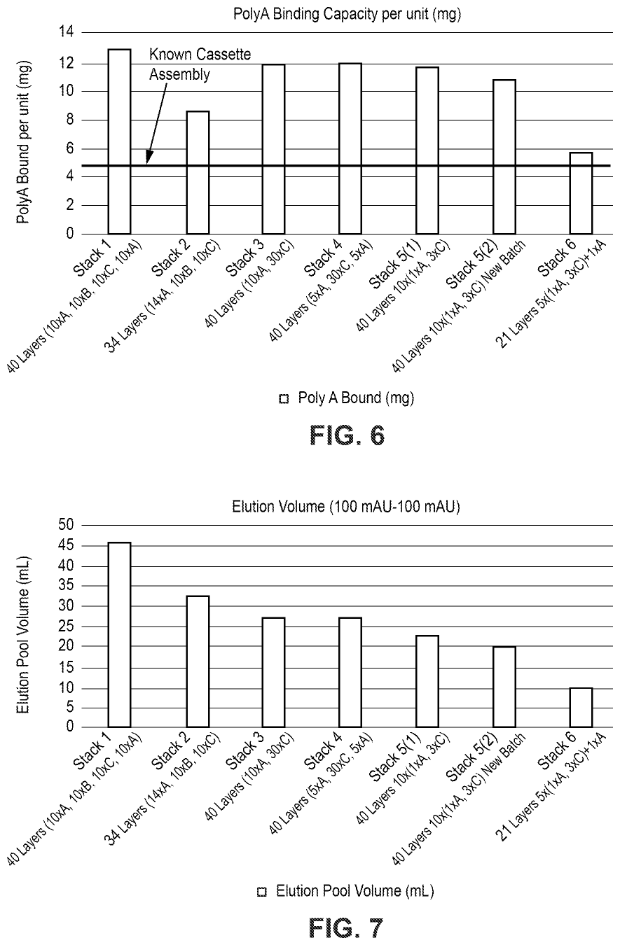

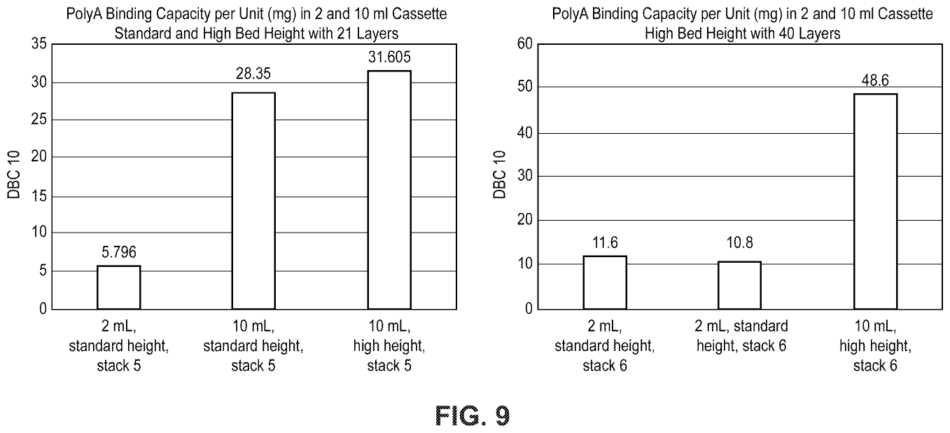

Membrane stack configurations consistent with the technology disclosed herein may advantageously improve productivity of cassette assemblies by accommodating a relative increase in filtration capacity. Membrane stacks having different individual membrane layers and/or membrane layers stacked in alternate sequences were tested in cassette assemblies consistent with the technology disclosed herein. The membrane layers used within the tested stacks had up to three different porosities. Membrane layer “Type 2” (a.k.a. “T2,” see FIGS. 9-12 a.k.a. “A,” see FIGS. 6-7) had a mean pore size of 0.45 microns, membrane layer “Type 3” ((a.k.a. “T3,” see FIGS. 9-12 a.k.a. “B,” see FIGS. 6-7) had a mean pore size of 1 micron, and membrane “Type 4” (a.k.a. “T4,” see FIGS. 9-12 a.k.a. “C,” see FIGS. 6-7) had a mean pore size of 3 microns. Each membrane layer had identical chemistry.

“Stack 1” has 40 membrane layers, 10 layers of Membrane A, 10 layers of Membrane B, 10 layers of Membrane C, and 10 layers of Membrane A were arranged consecutively from the inlet channel to the outlet channel of the cassette assembly. “Stack 2” has 34 membrane layers, 14 layers of Membrane A, 10 layers of Membrane B, and 10 layers of Membrane C were arranged consecutively from the inlet channel to the outlet channel of the cassette assembly. “Stack 3” has 40 membrane layers, 10 layers of Membrane A and 30 layers of Membrane C were arranged consecutively from the inlet channel to the outlet channel of the cassette assembly. “Stack 4” has 40 membrane layers including 5 layers of Membrane A, 30 layers of Membrane C, and 5 layers of Membrane A were arranged consecutively from the inlet channel to the outlet channel of the cassette assembly. “Stack 5” has 40 membrane layers including 1 layer of Membrane A and 3 layers of Membrane C, which was repeated in a regular pattern from the inlet channel to the outlet channel of the cassette assembly. “Stack 6” was additionally tested, which has 21 layers including one layer of Membrane A and 3 layers of Membrane C (thus, only 21 layers total) arranged consecutively from the inlet channel to the outlet channel of the cassette assembly.

Each of the membrane stacks were incorporated into a cassette consistent with the technology disclosed herein. Each cassette assembly having Stack 1 and 3-6 is configured such that the inlet cassette plate and the outlet cassette plate pinches the membrane stack around a perimeter region of the membrane stack to form a fluid seal. The compression results in compression approximately equal to the amount of compression (24.3%+/−3%) exerted on the perimeter region of a Known Cassette Assembly having only 19 identical membrane layers (Membrane A) pinched between the inlet cassette plate and the outlet cassette plate. The inlet cassette plate and the outlet cassette plate of the cassette assembly having Stack 2 were identical to the inlet cassette plate and the outlet cassette plate having 40 membrane layers (Stacks 1, and 3-5). The Known Cassette Assembly was otherwise identical to the tested cassette assemblies except that (1) the distance between the inlet cassette plate and the outlet cassette plate forming the compression structure of the Known Cassette Assembly was proportionally smaller than the distance between the inlet cassette plate and the outlet cassette plate in the compression structure of the tested cassette assemblies and (2) the number of membrane layers in the membrane stack. The chemistry of the membrane layers in the membrane stack of the Known Cassette Assembly is identical to the chemistry of the membrane layers in the membrane stack of the tested cassette assemblies.

### Dynamic Binding Capacity

The binding capacity may be determined as a dynamic binding capacity (“DBC”) by creating a breakthrough curve for a model target molecule. For example, to determine the DBC for an oligonucleotide, a poly adenosine (polyA) oligonucleotide may be used as the model target molecule. To determine the DBC for a protein, bovine serum albumin (BSA) may be used as the model target molecule. A fluid (such as a low ion strength fluid) containing the target molecule is passed through the membrane, typically at a flow rate of 1 ml/min, and the concentration of the model target molecule in the filtrate is measured and graphed as a function of loaded model target molecule mass divided by the bed volume (mg model target molecule per mL membrane). The concentration of the model target molecule can be determined spectrophotometrically. The DBC may be given, for example, as the load that would result in a 10% breakthrough of the target molecule, noted as “DBC10”. The DBC10 can be represented as the amount of the target molecule or model target molecule per volume of the unit (e.g., mg/unit).

The dynamic poly A binding capacity at 10% breakthrough (DBC10) of the layered separation media may be 1 mg/unit or greater, 2 mg/unit or greater, 3 mg/unit or greater, 4 mg/unit or greater, 5 mg/unit or greater, 6 mg/unit or greater, 7 mg/unit or greater, 8 mg/unit or greater, or 9 mg/unit or greater, 10 mg/unit or greater, 12 mg/unit or greater, 15 mg/unit or greater, 17 mg/unit or greater, 20 mg/unit or greater, 25 mg/unit or greater, 30 mg/unit or greater, 40 mg/unit or greater, 50 mg/unit or greater, or 75 mg/unit of greater. While there is no desired upper limit for the binding capacity, in practice, the dynamic poly A binding capacity (DBC10) may be 100 mg/unit or less, 75 mg/unit or less, 50 mg/unit or less, 40 mg/unit or less, 30 mg/unit or less 25 mg/unit or less, 20 mg/unit or less, 15 mg/unit or less, 12 mg/unit or less, 10 mg/unit or less, 9 mg/unit or less, 8 mg/unit or less, 7 mg/unit or less, 6 mg/unit or less, 5 mg/unit or less, 4 mg/unit or less, 3 mg/unit or less, or 2 mg/unit or less. The dynamic BSA binding capacity at 10% breakthrough (DBC10) of the layered separation media may be 50 mg/unit or greater, 80 mg/unit or greater, 100 mg/unit or greater, 125 mg/unit or greater, 150 mg/unit or greater, 200 mg/unit or greater, or 250 mg/unit or greater. While there is no desired upper limit for the binding capacity, in practice, the dynamic BSA binding capacity DBC10 may be 400 mg/unit or less or 350 mg/unit or less. That is, the dynamic BSA binding capacity (DBC10) of the layered separation media may be in a range of 50 mg/unit to 400 mg/unit, from 100 mg/unit to 400 mg/unit, from 150 mg/unit to 400 mg/unit, or from 200 mg/unit to 350 mg/unit.

The binding capacity at 10% breakthrough (DBC10) of five cassette assemblies, each having one of membrane stacks 1-6, is depicted in FIG. 6 and compared to the binding capacity of the Known Cassette Assembly. Two cassettes having Membrane Stack 5 were tested, Stack 5 (1) and Stack 5 (2). Each of the tested designs demonstrates an improved binding capacity compared to the Known Cassette Assembly.

The binding capacity at 10% breakthrough (DBC10) of various cassette assemblies, each having one of membrane stacks 6 and 5, is depicted in FIG. 9. Moving from left to right, a cassette assembly with an inner nominal volume of 2 mL is shown, followed by a cassette assembly with an inner nominal volume of 10 mL, 10 mL, 2 mL, 2 mL, and 10 mL at the far right. The assembly flow path (i.e., the inlet flow path, the outlet flow path, and a membrane stack cavity including the inlet channel, the membrane stack, and the outlet channel) may define an inner nominal volume. In other words, the inner nominal volume may define the entirety of the inner volume of the cassette assembly when in use and operating under normal internal and external pressures and temperatures. The inner nominal volume remains constant even as the membrane stack swells or contracts due to fluid flow, because the inner nominal volume is defined by the interior of the cassette plates 114, 120.

Again moving left to right in FIG. 9, the bed height within the cassette assembly (defined as the height of the cavity that houses the membrane stack) is standard, standard, high, standard, standard, high.

Referencing FIG. 9 and again moving left to right, the membrane stacks include: membrane stack 5, 5, 5, 6, 6, and 6, are shown. Further, the 2 mL cassette assemblies had DBC10 around 5 to 10 mg/unit. The 10 mL cassette assemblies had DBC10 around 30 to 50 mg/unit, which is around 5 times larger than the 2 mL cassette assemblies. This makes sense mathematically, or theoretically, as the cassette inner nominal volume is also around 5 times larger. However, in practice, this is surprising. Various other factors (cassette material strength under pressure, etc.) affect the utility of the cassette assembly, as discussed further herein. A higher bed height (comparing cassettes with the same inner nominal volume and membrane stack) also resulted in a higher binding capacity. This may advantageously allow for better binding of the target molecule.

A standard bed height may advantageously require less elution volume as discussed further herein. A standard bed height may advantageously reduce the time required to perform an application (e.g., bind and re-suspend a target molecule). A high bed height may advantageously result in lower internal pressure within the cassette assembly. A high bed height may advantageously result in a higher binding capacity, which means more target molecules are bound.

### Elution Volume

When the liquid containing the target molecule is passed through the membrane stack, the ligand or other binding sites on the membranes interact with the target molecule (e.g., through ionic bonds, covalent bonds, ligand-binding interactions, and the like). Through these interactions, the target molecule is temporarily immobilized on the membrane. Components of the liquid containing the target molecule that do not or cannot interact with the membrane are not immobilized and wash through the membrane stack. The membrane stack may release or elute the target molecule. The target molecule may be released, for example, by altering the environment, such as by changing the nature of the solvent passed through the separation media. The target molecule may be eluted by flowing an elution solution through the separation media. For example, the pH and/or ionic strength of the elution solution may be different from the binding solution (e.g., the liquid containing the target molecule that initially enters the membrane stack) to decrease strength of interactions between the membrane and the target molecule.

The elution volume is the amount of elution solution passed through the membrane stack to elute the target molecules. In some cases, the elution volume is the amount of elution solution needed to elute the target molecule (or model target molecule) at its binding capacity at 10% breakthrough (DBC10).

The elution volume can be given as the number of membrane volumes, or stack volumes needed to elute the target molecule (or model target molecule) at its 10% breakthrough binding capacity (DBC10). A stack volume is the sum of the volume of each layer. In some embodiments, the elution volume at the 10% breakthrough binding capacity test target molecule or target molecule is 1 stack volume or greater, 1.5 stack volumes or greater, 2 stack volumes or greater, 2.5 stack volumes or greater, 3 stack volumes or greater, 3.5 stack volumes or greater 4 stack volumes or greater, 4.5 stack volumes or grater, 5 stack volumes or greater, 6 stack volumes or greater, 7 stack volumes of greater, 8 stack volumes or greater, 9 stack volumes or greater, 10 stack volumes of greater, 15 stack volumes or greater, 20 stack volumes of greater, 30 stack volumes or grater, 40 stack volumes of grater, 50 stack columns or greater, or 75 stack volumes or greater. In some embodiments, the elution volume at the 10% breakthrough binding capacity test target molecule or target molecule is 100 stack volumes or less, 75 stack volumes or less, 50 stack volumes or less, 40 stack volumes or less, 30 stack volumes of less, 20 stack volumes or less, 15 stack volumes of less, 10 stack volumes or less, 9 stack volumes or less, 8 stack volumes or less, 7 stack volumes or less, 6 stack volumes or less, 5 stack volumes or less, 4.5 stack volumes or less, 4 stack volumes or less, 3.5 stack volumes of less, 3 stack volumes of less, 2.5 stack volumes or less, 2 stack volumes or less, or 1.5 stack volumes or less.

The elution volume of five cassette assemblies, each having one of membrane stacks 1-5, is depicted in FIG. 7. The elution volume was determined at the 10% breakthrough binding capacity of poly A for each stack (see FIG. 6). Stacks 3-5 demonstrate reduced elution volume compared to stacks 1 and 2, and the data generally demonstrates that performance of the cassette assembly is not only impacted by the particular mean pore size of the individual membrane layers in the stack, but also by the particular combination of membrane layers including the pattern that the membrane layers is stacked in.

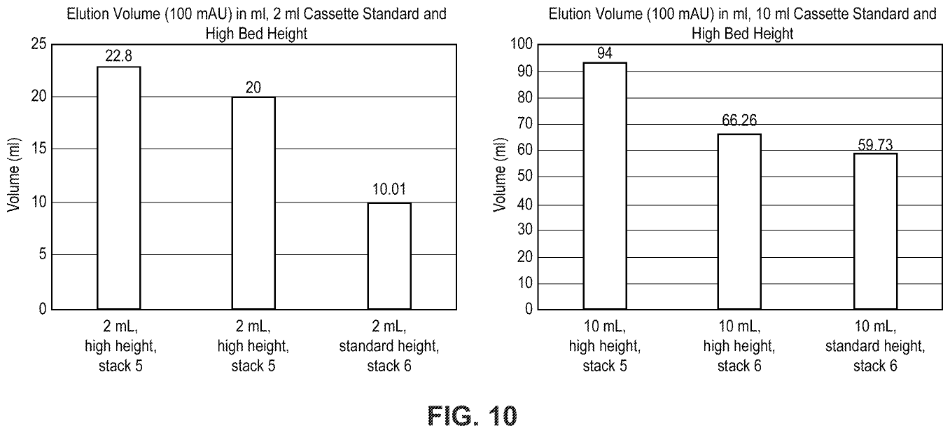

Test Results demonstrating the elution volume of various cassette assemblies, each having one of membrane stacks 6 and 5, is depicted in FIG. 10. Moving from left to right, the cassette assemblies had an inner nominal volume of 2 mL, 2 mL, 2 mL, 10 mL, 10 mL, and 10 mL. Again moving from left to right, the membrane stacks were membrane stack 5, 5, 6, 5, 6, and 6. Again moving from left to right, the bed height was high, high, standard, high, high, and standard. The elution volume was determined at the 10% breakthrough binding capacity of poly A for each stack (see related FIG. 6). Stacks with membrane stack 6 (21 layers) demonstrate reduced elution volume compared to stacks with membrane stack 5 (40 layers). The demonstrated reduced elution volume may be a result of less membrane layers requiring less elution volume. The data further generally demonstrates that performance of the cassette assembly is not only impacted by the particular mean pore size of the individual membrane layers in the stack, but also by the particular combination of membrane layers including the pattern that the membrane layers is stacked in. Further, the bed height did not appear to have a significant impact on elution volume, although slightly higher volumes were required for high bed height.

The ratio of a nominal membrane stack volume (in mL) to a fluid feed rate (in mL/min) may impact assembly performance. A nominal membrane stack volume is the sum of the volume of each layer prior to wetting (wetting the membrane stack can result in swelling of the membrane stack, which changes the membrane stack volume). In some embodiments the nominal stack volume is increased relative to the fluid feed rate. In particular, a ratio of the nominal membrane stack volume to an elution solution feed rate may be at least 1:1. In alternative embodiments, the ratio of the nominal membrane stack volume to fluid feed rate may be between 2:1 and 7:1. In one or more embodiments, a ratio of a nominal membrane stack volume (in mL) to a fluid feed rate (in mL/min) is 5:1. In one or more embodiments, a ratio of the nominal membrane stack volume to the first fluid feed rate may be at least 1:2.

In alternative embodiments, the nominal membrane stack volume can be less than the fluid feed rate, such as having a ratio of the nominal membrane stack volume to fluid feed rate may be between 1:1 and 1:3. In one or more embodiments, a ratio of the nominal membrane stack volume to the elution volume may be at least 1:5. In alternative embodiments, the ratio of the nominal membrane stack volume to the elution volume may be between 1:3 and 1:7.

### Elution Pressure

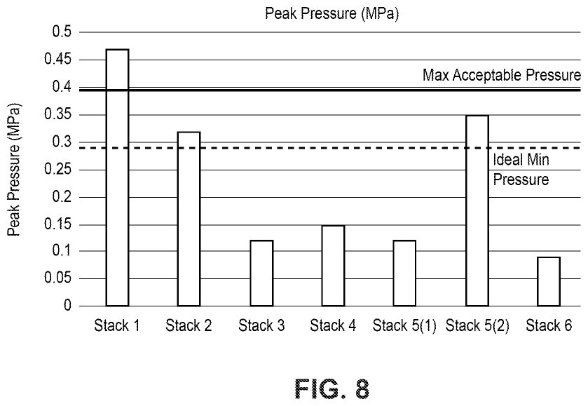

The elution pressure of five cassette assemblies consistent with the technology disclosed herein were tested, each having a membrane stack having a different configuration of the individual layers within the membrane stack. The data is depicted in FIG. 8. Stack 1, Stack 2, Stack 4, Stack 5 and Stack 6 were tested, which are described above. The flow rate was 0.5 CV through the cassette. The “Max Acceptable Pressure” and the “Ideal Min Pressure” shown on the graph is associated with one example implementation of the Known Cassette Assembly design described above, and is provided merely as one example. It should be noted that alternate implementations of cassette assemblies may have alternate ideal minimum and maximum acceptable pressures.

It is surprising that the Known Cassette Assembly, which has 19 Membrane A layers (each having a mean pore size of 0.45 microns), demonstrates lower elution pressure than Stack 1, for example, which has 20 Membrane A layers and 20 additional layers. Furthermore, Stack 1 also has notably higher elution pressure than the cassette assemblies having Stack 5, which also has 20 Membrane A layers. Thus, the elution pressure is not only impacted by the average pore size of the membrane layers, but the particular combinations of membrane layers including the pattern that the membrane layers are stacked in.

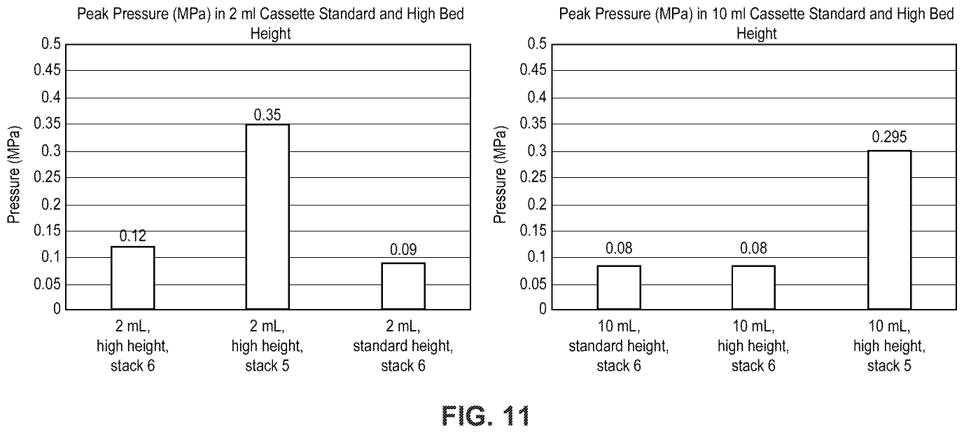

With respect to the data reflected in FIG. 11, the elution pressure of various cassette assemblies consistent with the technology disclosed herein were tested, each having a membrane stack having a different configuration of the individual layers within the membrane stack. Moving from left to right, the inner nominal volume was 2 mL, 2 mL, 2 mL, 10 mL, 10 mL, and 10 mL. Again moving from left to right, the membrane stack was membrane stack 6, 5, 6, 6, 6, and 5. Again moving from left to right, the bed height was high, high, standard, standard, high, high. The data demonstrates that the elution pressure is not only impacted by the average pore size of the membrane layers, but the particular combinations of membrane layers including the pattern that the membrane layers are stacked in. Further, bed height did not appear to have a significant impact on pressure for either inner nominal volume size (either 2 mL or 10 mL). For membrane stack 5, pressure was higher, which is logical as more membrane layers will require more pressure to flow fluid through the cassette assembly.

### Elution Concentration

In many cases, the target molecule is suspended in the first fluid, and the cassette assembly is used to remove the target molecule from the first fluid. For simplicity, a target molecule may be referred to in the singular but it is understood that a first fluid may include a plurality of target molecules of the same identity. A first fluid may also include two or more targets of different identity. The first fluid may be or include the media or lysate of a recombinant or natural expression system used to make the target molecule. As such, the first fluid may include other biomolecules or cellular debris. The membrane stack may be configured for concentrating the target molecule from a first fluid of already purified target. As such, the first fluid may include the target molecule, one or more buffering agents, and one or more salts. The first fluid containing the target molecule may also include solvents, such as water, an organic solvent, or a combination thereof, and soluble components dissolved in the solvent. The membrane stack may be configured for use with an organic solvent. The membrane stack may be configured to separate or purify the target molecules from a first fluid that includes an organic solvent.

Examples of suitable salts and buffering agents include sodium chloride; potassium chloride; lithium chloride; rubidium chloride; calcium chloride; magnesium chloride; cesium chloride; tris base (tris(hydroxymethyl)aminomethane); 4-(2-hydroxyethyl)-1-piperazineethanesulfonic acid (HEPES); 4-(2-hydroxyethyl) piperazine-1-propanesulfonic acid (EPPS); sodium phosphate; potassium phosphate; ammonium sulfate, 2-(N-morpholino)ethanesulfonic acid (MES); 2,2′,2″-Nitrilotriacetic acid (ADA); N-(2-Acetamido)-2-aminoethanesulfonic acid (ACES); 3-morpholino-2-hydroxypropanesulfonic acid (MOPSO); cholamine chloride hydrochloride; 3-(N-morpholino)propanesulfonic acid (MOPS); N,N-Bis(2-hydroxyethyl)-2-aminoethanesulfonic acid (BES); 2-{[1,3-Dihydroxy-2-(hydroxymethyl)propan-2-yl]amino}ethane-1-sulfonic acid (TES); 3-(N,N-Bis [2-hydroxyethyl]amino)-2-hydroxypropanesulfonic acid (DIPSO); 3-[N-Tris(hydroxymethyl)methylamino]-2-hydroxypropanesulfonic acid (TAPSO); acetamidoglycine; piperazine-1,4 BIS(2-hydroxypropanae sulphonic acid) (POPSO); N-(Hydroxyethyl)piperazine-N′-2-hydroxypropanesulfonic acid (HEPPSO); 3-[4-(2-Hydroxyethyl)piperazin-1-yl]propane-1-sulfonic acid (HEPPS); N-(Tri(hydroxymethyl)methyl)glycine (tricine); 2-Aminoacetamide; glycylglycine; N,N-Bis(2-hydroxyethyl)glycine; N-Tris(hydroxymethyl)methyl-3-aminopropanesulfonic acid (TAPS); and the like. Suitable salts and/or buffering agents may be added in an amount of 1 millimolar (mM) or greater, 5 mM or greater, or 10 mM or greater, 20 mM or greater, 50 mM or greater, 100 mM or greater 200 mM or greater, or 500 mM or greater. Suitable salts may be added in an amount of 1 M or less, 500 mM or less, 100 mM or less, 50 mM or less, or 30 mM or less. The salts may be added in an amount ranging from 1 mM to 1 M, 1 mM to 500 mM, 1 mM to 200 mM, 1 mM to 100 mM, 1 mM to 50 mM, 5 mM to 30 mM, 5 mM to 20 mM, or 20 mM to 100 mM.

In some embodiments, the first fluid includes one or more kosmotropic salts, one or more chaotropic salts, or both. Kosmotropic salts are known as salts that decrease the solubility of nonpolar substances in aqueous solutions. In contrast, chaotropic salts increase the solubility of nonpolar substances in aqueous solutions. In some embodiments, the amount and/or identity of a kosmotropic and/or chaotropic salts may be designed to increase the binding affinity and/or binding specificity between the target molecule and the affinity groups and/or assistance groups (if present).

Examples of kosmotropic salts that may be present in the first fluid include ammonium sulfate, ammonium phosphate, potassium phosphate, sodium sulfate, sodium chloride, and any combination thereof. Suitable kosmotropic salts may be present in the first fluid in an amount of 0.1 M or greater, 0.5 M or greater, or 1.0 M or greater, or 2.0 M or greater. Suitable kosmotropic salts may be present in the first fluid in an amount of 6.0 M or less, 5.0 M or less, or 4.0 M or less. The kosmotropic salts may be added in an amount ranging from 0.1 M to 6M, 0.5 M to 2.5 M, or 0.5 M to 3.0 M.

Examples of chaotropic salts that may be present in the first fluid include sodium chloride, calcium chloride, magnesium chloride and any combination thereof. In some embodiments, the first fluid includes 1 M or less, 0.5 M or less, or 0.1 M or less of chaotropic salts. In some embodiments, the first fluid is free or substantially free of chaotropic salts.

Suitable additives include glycerol and other polyols; protease inhibitors; phosphatase inhibitors; cryoprotectants; detergents; chelating agents; reducing agents; and any combination thereof Suitable additives may be present in the first fluid in amounts of 0.01 mM or greater, 0.1 mM or greater, 1 mM or greater, 5 mM or greater, 10 mM or greater, or 20 mM or greater. Suitable salts may be added in an amount of 100 mM or less, 50 mM or less, 30 mM or less, 10 mM or less, 5 mM or less, or 1 mM or less. Suitable additives may be present in the first fluid in amounts ranging from 0.01 mM to 100 mM, 1 mM to 50 mM, 5 mM to 30 mM, 5 mM to 20, 0.01 mM to 5 mM, or 1 mM to 5 mM.

In some embodiments, the carbohydrate binding domain often makes use of aa cofactor to bind to the target molecule. In such embodiments, the first fluid may include the cofactor or multiple cofactors. For example, in embodiments where the carbohydrate binding domain is the carbohydrate binding domain of the lectin or the full lectin protein, one or more cofactors may be included in the membrane stack.

The first fluid solvent may be any solvent that does not degrade or react with the target molecule. In some embodiments, the solvent includes water, an organic solvent, or both. In some embodiments, the solvent includes an organic solvent such as, for example, methanol, ethanol, isopropanol, and acetonitrile, DMSO, DMF, or any combination thereof. In some embodiments, the majority of the solvent is water. Alternatively, in some embodiments, the majority of the solvent may be made up of organic solvents. In some embodiments, the solvent is nonaqueous, e.g., consists of organic solvents.

The pH of the first fluid may be any pH that does not make the target molecule unstable or insoluble. Additionally, the pH of the first fluid should be such that the separation ligands of the separation media are not unstable. The pH of the first fluid may be controlled to enhance the binding affinity of the target molecules to any affinity groups and/or assistance group (if present) in the membrane stack.

The first fluid is contacted with the membrane stack such that the target molecules bind to at least a portion of the separation ligands that include an affinity group and/or an assistance group (if present) in the membrane stack. Molecules present in the solution that do not include a target molecule will not bind to the affinity group or will bind to the affinity group with a lesser affinity than the target molecule. Such off target molecules can be removed in an elution as discussed herein. Through binding to the affinity group, the target molecules are temporarily immobilized on the membrane stack.

The inlet flow path may be configured to receive the first fluid including the target molecule. The cassette assembly may retain the target molecule while allowing the first fluid to exit the cassette assembly. Then, the elution solution may be introduced, or washed through, the cassette assembly. Stated another way, the cassette assembly may be configured to receive the elution solution after the inlet flow path receives the first fluid. The elution solution may release the target molecule from the membrane stack, as discussed herein. The elution solution and the re-suspended target molecule may then flow out of the cassette assembly. In some implementations the elution solution and the re-suspended target molecule may be ready for use in various applications or may be further processed. The elution concentration is defined as the amount of the retained target molecule per milliliter of the first fluid over the elution volume.

The inner nominal volume is not particularly limited, but in some particular embodiments the inner nominal volume may be at least 2 mL, at least 5 mL, at least 10 mL, at least 20 mL, at least 30 mL, at least 40 mL, at least 0.5 liters, at least 1 liter, etc., and may be less than or equal to 1.5 liters, 0.75 liters, 50 mL, less than or equal to 35 mL, less than or equal to 25 mL, less than or equal to 15 mL, less than or equal to 7 mL, less than or equal to 4 mL, etc.

The elution concentration may be substantially constant, or stable, as the inner nominal volume varies. In other words, as the inner nominal volume is increased or decreased as the cassettes are made to be larger or smaller, the elution concentration will not change or will only change slightly. For example, the elution concentration may remain constant as inner nominal volume changes. Further, for example, the elution concentration may vary by less than or equal to 10% of the original elution concentration, less than or equal to 5% of the original elution concentration, less than or equal to 2% of the original elution concentration, etc. Still further, for example, the elution concentration may define a standard deviation of less than or equal to 0.2 ((milligrams of the retained target molecule) per ((milliliter of the first fluid)/(the elution volume))). In one or more embodiments, the elution concentration may be independent of the inner nominal volume.

A substantially constant, or stable, elution concentration as inner nominal volume varies is a surprising result of the present application. In general, as inner nominal volume varies, the internal pressures acting on the fluids and the physical components results in a variable elution concentration. Mathematically, it may seem simple that concentration remains unchanged because inner nominal volume and elution volume should change at the same rate. However, in practice, this is not the case. Variables such as internal pressures, choice of materials used, target molecule, first fluid, and elution fluid all affect elution concentration, and elution concentration does not generally remain substantially constant or stable. In fact, disproportionally more elution fluid is usually required as inner nominal volume increases. However, the present technology results in an elution concentration that does remain substantially constant, and stable. Thus, less elution solution is required when the present cassette assemblies are used. Less elution solution may advantageously result in a more concentrated target molecule re-suspended in elution solution. Less elution solution may advantageously save elution solution.

In one or more embodiments, a ratio of the inner nominal volume to the elution concentration remains 1:1, or remains close to 1:1, as the inner nominal volume varies. For example, the ratio of the inner nominal volume to the elution concentration may vary between 0.75:1 and 1.25:1. In alternative embodiments, the ratio of the inner nominal volume to the elution concentration may vary between 1:0.75 and 1:1.25.

In one or more embodiments, the elution concentration may be at least 0.4 ((milligrams of the retained target molecule) per ((milliliter of the first fluid)/(the elution volume))). In alternative embodiments, the elution concentration may be at least 0.1, 0.2, 0.5, 0.5, 0.7, etc. In further alternative embodiments, the elution concentration may be less than or equal to 1.0, 0.9, 0.8, 0.6, etc.

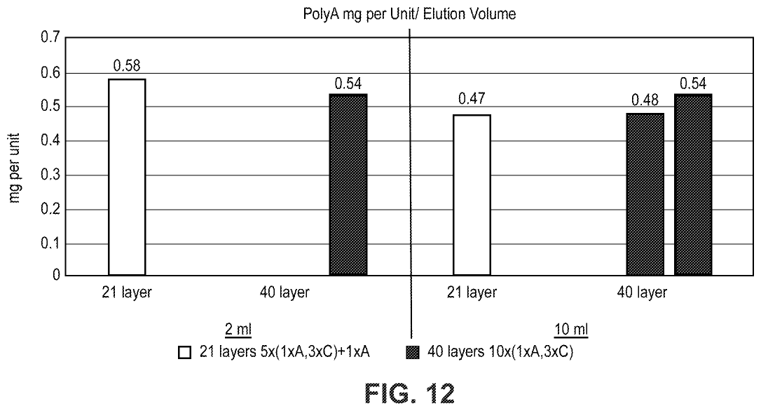

The elution concentration of various cassette assemblies consistent with the technology disclosed herein were tested (FIG. 12), each having a membrane stack having a different configuration of the individual layers within the membrane stack. Moving from left to right, the inner nominal volume was 2 mL, 2 mL, 10 mL, 10 mL, and 10 mL. Again moving from left to right, the membrane stack was membrane stack 6, 5, 6, 5, and 5. The data demonstrates that the elution concentration is not greatly impacted by the average pore size of the membrane layers, nor the particular combinations of membrane layers including the pattern that the membrane layers are stacked in. Instead, the elution concentration remains around 0.5 mg of PolyA per (mL first fluid/elution volume). This is surprising for the reasons described herein.

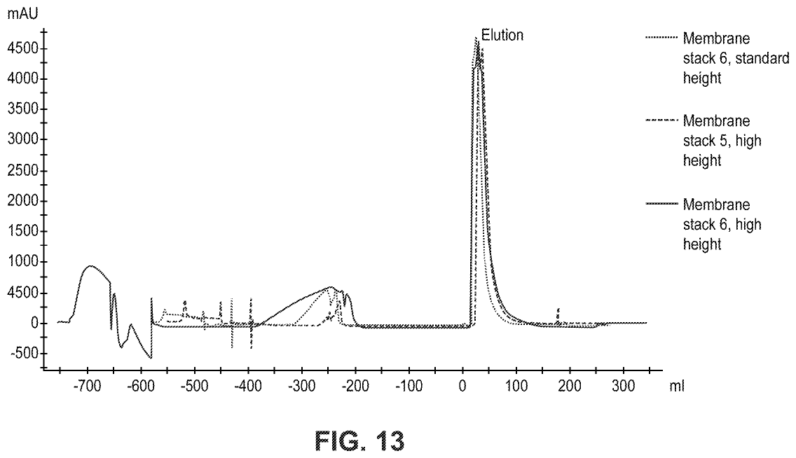

FIG. 13 illustrates example intensity of absorbance resulting from variations to the membrane layers of the membrane stack in example membrane chromatography cassette assemblies. Intensity of absorbance was measured using a chromatogram. All cassette assemblies had an inner nominal volume of 10 mL. Line 1 used membrane stack 6 in a standard bed height, line 2 used membrane stack 5 in an increased bed height, and line 3 used membrane stack 6 in an increased bed height. The data illustrates that lines 1 and 3 rise before line 2, and that line 1 has a narrower peak and drops down before lines 2 and 3. Thus, line 1 illustrates that membrane stack 6 in a standard bed height allows the elution to complete slightly faster than the other lines, which saves times during use of the cassette assembly in an application.

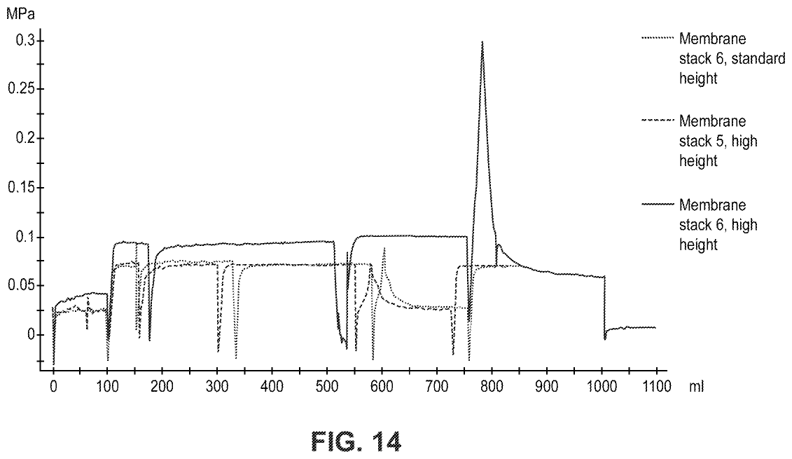

FIG. 14 illustrates example elution pressure for the same cassettes as described in FIG. 13. As shown, line 3 shows much higher pressures, at least because there are 40 layers of membranes and so more pressure is needed to move fluid through all the layers. Line 2 includes pressure drops slightly before line 1, likely because the increased bed height allows for more movement of the membrane stack within the bed compared to the standard bed height of line 1.

### Exemplary Aspects

Aspect 1. A cassette assembly comprising:
an inlet cassette plate defining an inlet flow path;
an outlet cassette plate configured to be arranged in a stack with the inlet cassette plate,
the outlet cassette plate defining an outlet flow path; and
a membrane stack having a first membrane layer having a first mean pore size and a second membrane layer having a second mean pore size different than the first mean pore size, the membrane stack disposed between the inlet cassette plate and the outlet cassette plate, wherein the inlet flow path is configured to be in fluid communication with the outlet flow path through the membrane stack to form an assembly flow path.

Aspect 2. The cassette assembly of any one of aspects 1 and 3-9, wherein the first mean pore size is 0.30 to 0.60 microns and the second mean pore size is 2.0 to 4.0 microns.

Aspect 3. The cassette assembly of any one of aspects 1-2 and 4-9, wherein the first membrane layer and the second membrane layer are arranged in a repeating pattern in the stack.

Aspect 4. The cassette assembly of any one of aspects 1-3 and 5-9, further comprising:
an inlet channel extending along an effective inlet surface area of the membrane stack in fluid communication with the inlet flow path; and
an outlet channel extending along an effective outlet surface area of the membrane stack towards the outlet flow path.

Aspect 5. The cassette assembly of any one of aspects 1-4 and 6-9, wherein the membrane stack comprises at least 30 membrane layers.

Aspect 6. The cassette assembly of any one of aspects 1-5 and 7-9, wherein the membrane stack has an effective inlet surface area defined by an effective length and an effective width, and wherein the effective length is at least 2.5 times the effective width.

Aspect 7. The cassette assembly of any one of aspects 1-6 and 8-9, further comprising:
an outlet channel spacer positioned in the outlet channel, wherein the outlet channel spacer is configured to accommodate fluid flow.

Aspect 8. The cassette assembly of any one of aspects 1-7 and 9, further comprising:
an inlet channel spacer positioned in the inlet channel, wherein the inlet channel spacer is configured to accommodate fluid flow.

Aspect 9. The cassette assembly of any one of aspects 1-8, further comprising:
a first end plate operatively couplable to the inlet cassette plate; and
a second end plate operatively couplable to the outlet cassette plate,
wherein the first end plate comprises an inlet port configured to extend to the inlet flow path, and
wherein the second end plate comprises an outlet port configured for fluid communication with the outlet flow path.

Aspect 10. A cassette assembly comprising: an inlet cassette plate defining an inlet flow path; an outlet cassette plate configured to be arranged in a stack with the inlet cassette plate, the outlet cassette plate defining an outlet flow path; and a membrane stack having a first membrane layer having a first mean pore size and a second membrane layer having a second mean pore size different than the first mean pore size, the membrane stack disposed between the inlet cassette plate and the outlet cassette plate, wherein the inlet flow path is configured to be in fluid communication with the outlet flow path through the membrane stack to form an assembly flow path.

Aspect 11. The cassette assembly of any one of aspects 10 and 12-18, wherein the first mean pore size is 0.30 to 0.60 microns and the second mean pore size is 2.0 to 4.0 microns.

Aspect 12. The cassette assembly of any one of aspects 10-11 and 13-18, wherein the first membrane layer and the second membrane layer are arranged in a repeating pattern in the stack.

Aspect 13. The cassette assembly of any one of aspects 10-12 and 14-18, further comprising: an inlet channel extending along an effective inlet surface area of the membrane stack in fluid communication with the inlet flow path; and an outlet channel extending along an effective outlet surface area of the membrane stack towards the outlet flow path.

Aspect 14. The cassette assembly of any one of aspects 10-13 and 15-18, wherein the membrane stack comprises at least 30 membrane layers.

Aspect 15. The cassette assembly of any one of aspects 10-14 and 16-18, wherein the membrane stack has an effective inlet surface area defined by an effective length and an effective width, and wherein the effective length is at least 2.5 times the effective width.

Aspect 16. The cassette assembly of any one of aspects 10-15 and 17-18, further comprising: an outlet channel spacer positioned in the outlet channel, wherein the outlet channel spacer is configured to accommodate fluid flow.

Aspect 17. The cassette assembly of any one of aspects 10-16 and 18-18, further comprising: an inlet channel spacer positioned in the inlet channel, wherein the inlet channel spacer is configured to accommodate fluid flow.

Aspect 18. The cassette assembly of any one of aspects 10-17, further comprising: a first end plate operatively couplable to the inlet cassette plate; and a second end plate operatively couplable to the outlet cassette plate, wherein the first end plate comprises an inlet port configured to extend to the inlet flow path, and wherein the second end plate comprises an outlet port configured for fluid communication with the outlet flow path.

Aspect 19. A cassette assembly comprising: an inlet cassette plate defining an inlet flow path configured to receive a first fluid including a target molecule; an outlet cassette plate configured to be arranged in a stack with the inlet cassette plate, the outlet cassette plate defining an outlet flow path; and a membrane stack having at least one membrane layer, wherein the membrane stack is disposed between the inlet cassette plate and the outlet cassette plate and the membrane stack is configured to retain the target molecule, wherein the inlet flow path is configured to be in fluid communication with the outlet flow path through the membrane stack to form an assembly flow path, and the assembly flow path defines an inner nominal volume, and wherein the cassette assembly is configured to receive an elution solution after the inlet flow path receives the first fluid, and an elution concentration is substantially constant as the inner nominal volume varies.

Aspect 20. The cassette assembly of any one of aspects 19 and 21-37, further comprising: an inlet channel extending along an effective inlet surface area of the membrane stack in fluid communication with the inlet flow path; and an outlet channel extending along an effective outlet surface area of the membrane stack towards the outlet flow path.

Aspect 21. The cassette assembly of any one of aspects 19-20 and 22-37, wherein the membrane stack comprises a first membrane layer having a first mean pore size and a second membrane layer having a second mean pore size different from the first mean pore size.

Aspect 22. The cassette assembly of any one of aspects 19-21 and 23-37, wherein the first mean pore size is 0.30 to 0.60 microns and the second mean pore size is 2.0 to 4.0 microns.

Aspect 23. The cassette assembly of any one of aspects 19-22 and 24-37, wherein the first membrane layer and the second membrane layer are arranged in a repeating pattern in the stack.

Aspect 24. The cassette assembly of any one of aspects 19-23 and 25-37, wherein the first mean pore size is 0.50 to 1.50 microns and the second mean pore size is 2.50 to 3.50 microns.

Aspect 25. The cassette assembly of any one of aspects 19-24 and 26-37, wherein the membrane stack comprises 6 first membrane layers and 15 second membrane layers.

Aspect 26. The cassette assembly of any one of aspects 19-25 and 27-37, wherein the membrane stack comprises 10 first membrane layers and 30 second membrane layers.

Aspect 27. The cassette assembly of any one of aspects 19-26 and 28-37, wherein the first membrane layer and the second membrane layer are arranged in a repeating pattern of one first membrane layer and three second membrane layers in the stack.

Aspect 28. The cassette assembly of any one of aspects 19-27 and 29-37, wherein the first membrane layer and the second membrane layer are arranged with one first membrane layer at one end of the membrane stack, and a repeating pattern of one first membrane layer and three second membrane layers in the stack thereafter.

Aspect 29. The cassette assembly of any one of aspects 19-28 and 30-37, wherein a ratio of an inner nominal membrane stack volume (milliliters) to a fluid feed rate (milliliters/minute) is 5:1.

Aspect 30. The cassette assembly of any one of aspects 19-29 and 31-37, wherein the membrane stack comprises at least 20 membrane layers.

Aspect 31. The cassette assembly of any one of aspects 19-30 and 32-37, wherein a ratio of a nominal membrane stack volume to a first fluid feed rate is at least 1:2.

Aspect 32. The cassette assembly of any one of aspects 19-31 and 33-37, wherein a ratio of a nominal membrane stack volume to an elution solution feed rate is at least 1:1.

Aspect 33. The cassette assembly of any one of aspects 19-32 and 34-37, wherein a ratio of a nominal membrane stack volume to an elution volume is at least 1:5.

Aspect 34. The cassette assembly of any one of aspects 19-33 and 35-37, wherein the inner nominal volume is at least 2 milliliters and up to and including 50 milliliters.

Aspect 35. The cassette assembly of any one of aspects 19-34 and 36-37, wherein the elution concentration is an amount of the retained target molecule per: milliliter of the first fluid over an elution volume.

Aspect 36. The cassette assembly of any one of aspects 19-35 and 37, wherein the elution concentration is at least 0.4 ((milligrams of the retained target molecule) per ((milliliter of the first fluid)/(the elution volume))).

Aspect 37. The cassette assembly of any one of aspects 19-36, wherein the membrane stack has an effective inlet surface area defined by an effective length and an effective width, and wherein the effective length is at least 2.5 times the effective width.

Aspect 38. A cassette assembly comprising: an inlet cassette plate defining an inlet flow path configured to receive a first fluid including a target molecule; an outlet cassette plate configured to be arranged in a stack with the inlet cassette plate, the outlet cassette plate defining an outlet flow path; and a membrane stack having at least one membrane layer, wherein the membrane stack is disposed between the inlet cassette plate and the outlet cassette plate and the membrane stack is configured to retain the target molecule, wherein the inlet flow path is configured to be in fluid communication with the outlet flow path through the membrane stack to form an assembly flow path, and the assembly flow path defines an inner nominal volume, and wherein the cassette assembly is configured to receive an elution solution after the inlet flow path receives the first fluid, and a ratio of the inner nominal volume to an elution concentration ((milligrams of the retained target molecule) per ((milliliter of the first fluid)/(the elution volume))) remains 1:1 as the inner nominal volume varies.

Aspect 39. The cassette assembly of any one of aspects 38 and 40-56, further comprising: an inlet channel extending along an effective inlet surface area of the membrane stack in fluid communication with the inlet flow path; and an outlet channel extending along an effective outlet surface area of the membrane stack towards the outlet flow path.

Aspect 40. The cassette assembly of any one of aspects 38-39 and 41-56, wherein the membrane stack comprises a first membrane layer having a first mean pore size and a second membrane layer having a second mean pore size different from the first mean pore size.

Aspect 41. The cassette assembly of any one of aspects 38-40 and 42-56, wherein the first mean pore size is 0.30 to 0.60 microns and the second mean pore size is 2.0 to 4.0 microns.

Aspect 42. The cassette assembly of any one of aspects 38-41 and 43-56, wherein the first membrane layer and the second membrane layer are arranged in a repeating pattern in the stack.

Aspect 43. The cassette assembly of any one of aspects 38-42 and 44-56, wherein the first mean pore size is 0.50 to 1.50 microns and the second mean pore size is 2.50 to 3.50 microns.

Aspect 44. The cassette assembly of any one of aspects 38-43 and 45-56, wherein the membrane stack comprises 6 first membrane layers and 15 second membrane layers.

Aspect 45. The cassette assembly of any one of aspects 38-44 and 46-56, wherein the membrane stack comprises 10 first membrane layers and 30 second membrane layers.

Aspect 46. The cassette assembly of any one of aspects 38-45 and 47-56, wherein the first membrane layer and the second membrane layer are arranged in a repeating pattern of one first membrane layer and three second membrane layers in the stack.

Aspect 47. The cassette assembly of any one of aspects 38-46 and 48-56, wherein the first membrane layer and the second membrane layer are arranged with one first membrane layer at one end of the membrane stack, and a repeating pattern of one first membrane layer and three second membrane layers in the stack thereafter.

Aspect 48. The cassette assembly of any one of aspects 38-47 and 49-56, wherein a ratio of an inner nominal membrane stack volume (milliliters) to a fluid feed rate (milliliters/minute) is 5:1.

Aspect 49. The cassette assembly of any one of aspects 38-48 and 50-56, wherein the membrane stack comprises at least 20 membrane layers.

Aspect 50. The cassette assembly of any one of aspects 38-49 and 51-56, wherein a ratio of a nominal membrane stack volume to a first fluid feed rate is at least 1:2.

Aspect 51. The cassette assembly of any one of aspects 38-50 and 52-56, wherein a ratio of a nominal membrane stack volume to an elution solution feed rate is at least 1:1.

Aspect 52. The cassette assembly of any one of aspects 38-51 and 53-56, wherein a ratio of a nominal membrane stack volume to an elution volume is at least 1:5.

Aspect 53. The cassette assembly of any one of aspects 38-52 and 54-56, wherein the inner nominal volume is at least 2 milliliters and up to and including 50 milliliters.

Aspect 54. The cassette assembly of any one of aspects 38-53 and 55-56, wherein the elution concentration is an amount of the retained target molecule per: milliliter of the first fluid over an elution volume.

Aspect 55. The cassette assembly of any one of aspects 38-54 and 56-56, wherein the elution concentration is at least 0.4 ((milligrams of the retained target molecule) per ((milliliter of the first fluid)/(the elution volume))).

Aspect 56. The cassette assembly of any one of aspects 38-55, wherein the membrane stack has an effective inlet surface area defined by an effective length and an effective width, and wherein the effective length is at least 2.5 times the effective width.

Aspect 57. A cassette assembly comprising: an inlet cassette plate defining an inlet flow path configured to receive a first fluid including a target molecule; an outlet cassette plate configured to be arranged in a stack with the inlet cassette plate, the outlet cassette plate defining an outlet flow path; and a membrane stack having at least one membrane layer, wherein the membrane stack is disposed between the inlet cassette plate and the outlet cassette plate and the membrane stack is configured to retain the target molecule, wherein the inlet flow path is configured to be in fluid communication with the outlet flow path through the membrane stack to form an assembly flow path, and the assembly flow path defines an inner nominal volume.

Aspect 58. The cassette assembly of any one of aspects 57 and 59-76, wherein the cassette assembly is configured to receive an elution solution after the inlet flow path receives the first fluid, and an elution concentration is independent of the inner nominal volume.

Aspect 59. The cassette assembly of any one of aspects 57-58 and 60-76, further comprising: an inlet channel extending along an effective inlet surface area of the membrane stack in fluid communication with the inlet flow path; and an outlet channel extending along an effective outlet surface area of the membrane stack towards the outlet flow path.

Aspect 60. The cassette assembly of any one of aspects 57-59 and 61-76, wherein the membrane stack comprises a first membrane layer having a first mean pore size and a second membrane layer having a second mean pore size different from the first mean pore size.

Aspect 61. The cassette assembly of any one of aspects 57-60 and 62-76, wherein the first mean pore size is 0.30 to 0.60 microns and the second mean pore size is 2.0 to 4.0 microns.

Aspect 62. The cassette assembly of any one of aspects 57-61 and 63-76, wherein the first membrane layer and the second membrane layer are arranged in a repeating pattern in the stack.

Aspect 63. The cassette assembly of any one of aspects 57-62 and 64-76, wherein the first mean pore size is 0.50 to 1.50 microns and the second mean pore size is 2.50 to 3.50 microns.

Aspect 64. The cassette assembly of any one of aspects 57-63 and 65-76, wherein the membrane stack comprises 6 first membrane layers and 15 second membrane layers.

Aspect 65. The cassette assembly of any one of aspects 57-64 and 66-76, wherein the membrane stack comprises 10 first membrane layers and 30 second membrane layers.

Aspect 66. The cassette assembly of any one of aspects 57-65 and 67-76, wherein the first membrane layer and the second membrane layer are arranged in a repeating pattern of one first membrane layer and three second membrane layers in the stack.

Aspect 67. The cassette assembly of any one of aspects 57-66 and 68-76, wherein the first membrane layer and the second membrane layer are arranged with one first membrane layer at one end of the membrane stack, and a repeating pattern of one first membrane layer and three second membrane layers in the stack thereafter.

Aspect 68. The cassette assembly of any one of aspects 57-67 and 69-76, wherein a ratio of an inner nominal membrane stack volume (milliliters) to a fluid feed rate (milliliters/minute) is 5:1.

Aspect 69. The cassette assembly of any one of aspects 57-68 and 70-76, wherein the membrane stack comprises at least 20 membrane layers.

Aspect 70. The cassette assembly of any one of aspects 57-69 and 71-76, wherein a ratio of a nominal membrane stack volume to a first fluid feed rate is at least 1:2.

Aspect 71. The cassette assembly of any one of aspects 57-70 and 72-76, wherein a ratio of a nominal membrane stack volume to an elution solution feed rate is at least 1:1.

Aspect 72. The cassette assembly of any one of aspects 57-71 and 73-76, wherein a ratio of a nominal membrane stack volume to an elution volume is at least 1:5.

Aspect 73. The cassette assembly of any one of aspects 57-72 and 74-76, wherein the inner nominal volume is at least 2 milliliters and up to and including 50 milliliters.

Aspect 74. The cassette assembly of any one of aspects 57-73 and 75-76, wherein the elution concentration is an amount of the retained target molecule per: milliliter of the first fluid over an elution volume.

Aspect 75. The cassette assembly of any one of aspects 57-74 and 76, wherein the elution concentration is at least 0.4 ((milligrams of the retained target molecule) per ((milliliter of the first fluid)/(the elution volume))).

Aspect 76. The cassette assembly of any one of aspects 57-75, wherein the membrane stack has an effective inlet surface area defined by an effective length and an effective width, and wherein the effective length is at least 2.5 times the effective width.

It should be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A cassette assembly comprising:
an inlet cassette plate defining an inlet flow path configured to receive a first fluid including a target molecule;
an outlet cassette plate configured to be arranged in a stack with the inlet cassette plate, the outlet cassette plate defining an outlet flow path; and
a membrane stack having at least one membrane layer, wherein the membrane stack is disposed between the inlet cassette plate and the outlet cassette plate and the membrane stack is configured to retain the target molecule,
wherein the inlet flow path is configured to be in fluid communication with the outlet flow path through the membrane stack to form an assembly flow path, and the assembly flow path defines an inner nominal volume, and
wherein the cassette assembly is configured to receive an elution solution after the inlet flow path receives the first fluid, and an elution concentration is substantially constant as the inner nominal volume varies.

2. The cassette assembly of claim 1, further comprising:
an inlet channel extending along an effective inlet surface area of the membrane stack in fluid communication with the inlet flow path; and
an outlet channel extending along an effective outlet surface area of the membrane stack towards the outlet flow path.

3. The cassette assembly of claim 1, wherein the membrane stack comprises a first membrane layer having a first mean pore size and a second membrane layer having a second mean pore size different from the first mean pore size.

4. The cassette assembly of claim 3, wherein the first mean pore size is 0.30 to 0.60 microns and the second mean pore size is 2.0 to 4.0 microns.

5. The cassette assembly of claim 4, wherein the first membrane layer and the second membrane layer are arranged in a repeating pattern in the stack.

6. The cassette assembly of claim 5, wherein the first mean pore size is 0.50 to 1.50 microns and the second mean pore size is 2.50 to 3.50 microns.

7. The cassette assembly of claim 6, wherein the membrane stack comprises 6 first membrane layers and 15 second membrane layers.

8. The cassette assembly of claim 1, wherein the membrane stack comprises 10 first membrane layers and 30 second membrane layers.

9. The cassette assembly of claim 8, wherein the first membrane layer and the second membrane layer are arranged in a repeating pattern of one first membrane layer and three second membrane layers in the stack.

10. The cassette assembly of claim 3, wherein the first membrane layer and the second membrane layer are arranged with one first membrane layer at one end of the membrane stack, and a repeating pattern of one first membrane layer and three second membrane layers in the stack thereafter.

11. The cassette assembly of claim 1, wherein a ratio of an inner nominal membrane stack volume (milliliters) to a fluid feed rate (milliliters/minute) is 5:1.

12. The cassette assembly of claim 1, wherein the membrane stack comprises at least 20 membrane layers.

13. The cassette assembly of claim 1, wherein a ratio of a nominal membrane stack volume to a first fluid feed rate is at least 1:2.

14. The cassette assembly of claim 1, wherein a ratio of a nominal membrane stack volume to an elution solution feed rate is at least 1:1.

15. The cassette assembly of claim 1, wherein a ratio of a nominal membrane stack volume to an elution volume is at least 1:5.

16. The cassette assembly of claim 1, wherein the inner nominal volume is at least 2 milliliters and up to and including 50 milliliters.

17. The cassette assembly of claim 1, wherein the elution concentration is an amount of the retained target molecule per: milliliter of the first fluid over an elution volume.

18. The cassette assembly of claim 1, wherein the elution concentration is at least 0.4 ((milligrams of the retained target molecule) per ((milliliter of the first fluid)/(the elution volume))).

19. A cassette assembly comprising:
an inlet cassette plate defining an inlet flow path configured to receive a first fluid including a target molecule;
an outlet cassette plate configured to be arranged in a stack with the inlet cassette plate, the outlet cassette plate defining an outlet flow path; and
a membrane stack having at least one membrane layer, wherein the membrane stack is disposed between the inlet cassette plate and the outlet cassette plate and the membrane stack is configured to retain the target molecule,
wherein the inlet flow path is configured to be in fluid communication with the outlet flow path through the membrane stack to form an assembly flow path, and the assembly flow path defines an inner nominal volume, and
wherein the cassette assembly is configured to receive an elution solution after the inlet flow path receives the first fluid, and a ratio of the inner nominal volume to an elution concentration ((milligrams of the retained target molecule) per ((milliliter of the first fluid)/(the elution volume))) remains 1:1 as the inner nominal volume varies.

20. A cassette assembly comprising:
an inlet cassette plate defining an inlet flow path;
an outlet cassette plate configured to be arranged in a stack with the inlet cassette plate, the outlet cassette plate defining an outlet flow path; and
a membrane stack having a first membrane layer having a first mean pore size and a second membrane layer having a second mean pore size different than the first mean pore size, the membrane stack disposed between the inlet cassette plate and the outlet cassette plate, wherein the inlet flow path is configured to be in fluid communication with the outlet flow path through the membrane stack to form an assembly flow path.
